(19) United States
(12) Patent Application Publication
(10) Pub. No.: US 2023/0345575 A1
(43) Pub. Date: Oct. 26, 2023

(54) METHOD AND DEVICE FOR PERFORMING COMMUNICATION IN NR V2X ON BASIS OF SL DRX

(71) Applicant: LG ELECTRONICS INC., Seoul (KR)

(72) Inventors: Woosuk KO, Seoul (KR); Hanbyul SEO, Seoul (KR)

(73) Assignee: LG ELECTRONICS INC., Seoul (KR)

(21) Appl. No.: 18/026,717

(22) PCT Filed: Sep. 16, 2021
(86) PCT No.: PCT/KR2021/012675

§ 371 Date: Mar. 16, 2023

(30) Foreign Application Priority Data
Sep. 16, 2020 (KR) 1020200118983
Sep. 16, 2020 (KR) 1020200119356
Sep. 17, 2020 (KR) 1020200120022
Sep. 25, 2020 (KR) 1020200124632

(51) Int. Cl. H04W 76/28; H04W 72/25

(52) U.S. Cl. CPC H04W 76/28; H04W 72/25; H04W 92/18

(57) ABSTRACT

Provided are a method for a first device to perform wireless communication on the basis of a sidelink (SL) discontinuous reception (DRX) setting, and a device for supporting same. The method may comprise the steps of: receiving first sidelink control information (SCI) for scheduling a physical sidelink shared channel (PSSCH) from a second device through a physical sidelink control channel (PSCCH) on the basis of a first resource within a first active time among a plurality of SL resources, wherein information related to the first active time is included in the SL DRX setting; receiving data and second SCI including a source ID and a destination ID through the PSSCH from the second device; determining the value of a timer related to a second active time on the basis of a threshold value and time intervals between the plurality of SL resources; and initiating the timer related to the second active time.

### TECHNICAL FIELD

This disclosure relates to a wireless communication system.

### BACKGROUND

Sidelink (SL) communication is a communication scheme in which a direct link is established between User Equipments (UEs) and the UEs exchange voice and data directly with each other without intervention of an evolved Node B (eNB). SL communication is under consideration as a solution to the overhead of an eNB caused by rapidly increasing data traffic. Vehicle-to-everything (V2X) refers to a communication technology through which a vehicle exchanges information with another vehicle, a pedestrian, an object having an infrastructure (or infra) established therein, and so on. The V2X may be divided into 4 types, such as vehicle-to-vehicle (V2V), vehicle-to-infrastructure (V2I), vehicle-to-network (V2N), and vehicle-to-pedestrian (V2P). The V2X communication may be provided via a PC5 interface and/or Uu interface.

Meanwhile, as a wider range of communication devices require larger communication capacities, the need for mobile broadband communication that is more enhanced than the existing Radio Access Technology (RAT) is rising. Accordingly, discussions are made on services and user equipment (UE) that are sensitive to reliability and latency. And, a next generation radio access technology that is based on the enhanced mobile broadband communication, massive Machine Type Communication (MTC), Ultra-Reliable and Low Latency Communication (URLLC), and so on, may be referred to as a new radio access technology (RAT) or new radio (NR). Herein, the NR may also support vehicle-to-everything (V2X) communication.

FIG. 1 is a drawing for describing V2X communication based on NR, compared to V2X communication based on RAT used before NR. The embodiment of FIG. 1 may be combined with various embodiments of the present disclosure.

Regarding V2X communication, a scheme of providing a safety service, based on a V2X message such as Basic Safety Message (BSM), Cooperative Awareness Message (CAM), and Decentralized Environmental Notification Message (DENM) is focused in the discussion on the RAT used before the NR. The V2X message may include position information, dynamic information, attribute information, or the like. For example, a UE may transmit a periodic message type CAM and/or an event triggered message type DENM to another UE.

Thereafter, regarding V2X communication, various V2X scenarios are proposed in NR. For example, the various V2X scenarios may include vehicle platooning, advanced driving, extended sensors, remote driving, or the like.

### DETAILED DESCRIPTION OF THE INVENTION

### Summary

Meanwhile, in order to ensure communication between UEs performing the SL DRX operation, SL DRX cycles and active times need to be aligned among the UEs. To this end, for example, the TX UE may transmit an SL DRX configuration to the RX UE. For example, if a connection is established between the base station and the TX UE, the base station may transmit an SL DRX configuration to the TX UE, and the TX UE may transmit the SL DRX configuration to the RX UE. Meanwhile, in the SL DRX operation, an active time may be changed by a timer. In this case, if the TX UE transmits a configuration for the timer to the RX UE whenever the configuration for the timer is changed, signaling overhead may increase. Therefore, in order to reduce signaling overhead, it is necessary to propose a method for adjusting an active time by the TX UE and the RX UE based on a predefined (implicit) rule.

In one embodiment, provided is a method for performing wireless communication by a first device based on a sidelink (SL) discontinuous reception (DRX) configuration. The method may comprise: receiving, from a second device, first sidelink control information (SCI) for scheduling a physical sidelink shared channel (PSSCH) through a physical sidelink control channel (PSCCH), based on a first resource within a first active time among a plurality of SL resources, wherein information related to the first active time is included in the SL DRX configuration; receiving, from the second device, data and second SCI including a source ID and a destination ID through the PSSCH; determining, based on a time interval between the plurality of SL resources and a threshold, a value of a timer related to a second active time; and starting the timer related to the second active time.

In one embodiment, provided is a first device adapted to perform wireless communication based on a sidelink (SL) discontinuous reception (DRX) configuration. The first device may comprise: one or more memories storing instructions; one or more transceivers; and one or more processors connected to the one or more memories and the one or more transceivers. For example, the one or more processors may execute the instructions to: receive, from a second device, first sidelink control information (SCI) for scheduling a physical sidelink shared channel (PSSCH) through a physical sidelink control channel (PSCCH), based on a first resource within a first active time among a plurality of SL resources, wherein information related to the first active time is included in the SL DRX configuration; receive, from the second device, data and second SCI including a source ID and a destination ID through the PSSCH; determine, based on a time interval between the plurality of SL resources and a threshold, a value of a timer related to a second active time; and start the timer related to the second active time.

Power consumption of the UE can be saved.

### BRIEF DESCRIPTION OF THE DRAWINGS

FIG. 1 is a drawing for describing V2X communication based on NR, compared to V2X communication based on RAT used before NR.

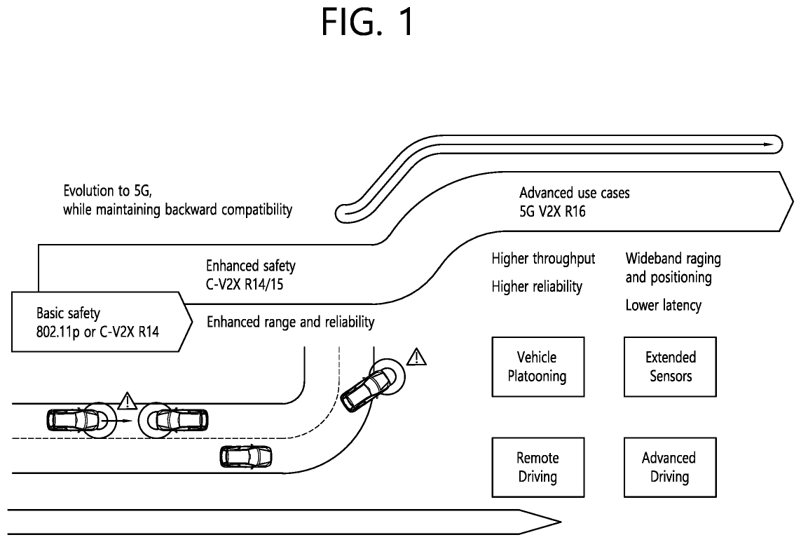

FIG. 2 shows a structure of an NR system, based on an embodiment of the present disclosure.

FIG. 3 shows a radio protocol architecture, based on an embodiment of the present disclosure.

FIG. 4 shows a structure of a radio frame of an NR, based on an embodiment of the present disclosure.

FIG. 5 shows a structure of a slot of an NR frame, based on an embodiment of the present disclosure.

FIG. 6 shows an example of a BWP, based on an embodiment of the present disclosure.

FIG. 7 shows a UE performing V2X or SL communication, based on an embodiment of the present disclosure.

FIG. 8 shows a procedure of performing V2X or SL communication by a UE based on a transmission mode, based on an embodiment of the present disclosure.

FIG. 9 shows three cast types, based on an embodiment of the present disclosure.

FIG. 10 shows an example of a DRX cycle, based on an embodiment of the present disclosure.

FIG. 11 shows a method for determining, by a UE, a timer value to include all timings of a plurality of resources if a time interval between the plurality of resources is less than (or less than or equal to) a threshold, based on an embodiment of the present disclosure.

FIG. 12 shows a method for determining, by a UE, a timer to include timing for only one resource among a plurality of resources if a time interval between the plurality of resources is greater than (or greater than or equal to) a threshold, based on an embodiment of the present disclosure.

FIG. 13 shows a method for determining, by a UE, a timer value to include timing for a PSFCH resource if a time interval between a PSCCH/PSSCH resource and the PSFCH resource is less than a threshold, based on an embodiment of the present disclosure.

FIG. 14 shows a procedure for determining a timer value by a first device and a second device, based on an embodiment of the present disclosure.

FIG. 15 shows a procedure for a DRX operating UE to perform SL communication based on a DRX long cycle or a DRX short cycle, based on an embodiment of the present disclosure.

FIG. 16 shows a procedure for a UE to perform SL communication based on an SL DRX mode 1 or an SL DRX mode 2, based on an embodiment of the present disclosure.

FIG. 17 shows a method for a second device to transmit TBs in an interlace form, based on an embodiment of the present disclosure.

FIG. 18 shows a method for a second device to transmit TBs in a burst form, based on an embodiment of the present disclosure.

FIG. 19 shows a method for a first device to perform wireless communication based on a sidelink (SL) discontinuous reception (DRX) configuration, based on an embodiment of the present disclosure.

FIG. 20 shows a method for a second device to perform wireless communication based on a sidelink (SL) discontinuous reception (DRX) configuration, based on an embodiment of the present disclosure.

FIG. 21 shows a communication system 1, based on an embodiment of the present disclosure.

FIG. 22 shows wireless devices, based on an embodiment of the present disclosure.

FIG. 23 shows a signal process circuit for a transmission signal, based on an embodiment of the present disclosure.

FIG. 24 shows another example of a wireless device, based on an embodiment of the present disclosure.

FIG. 25 shows a hand-held device, based on an embodiment of the present disclosure.

FIG. 26 shows a vehicle or an autonomous vehicle, based on an embodiment of the present disclosure.

### DETAILED DESCRIPTION

In the present disclosure, “A or B” may mean “only A”, “only B” or “both A and B.” In other words, in the present disclosure, “A or B” may be interpreted as “A and/or B”. For example, in the present disclosure, “A, B, or C” may mean “only A”, “only B”, “only C”, or “any combination of A, B, C”.

A slash (/) or comma used in the present disclosure may mean “and/or”. For example, “A/B” may mean “A and/or B”. Accordingly, “A/B” may mean “only A”, “only B”, or “both A and B”. For example, “A, B, C” may mean “A, B, or C”.

In the present disclosure, “at least one of A and B” may mean “only A”, “only B”, or “both A and B”. In addition, in the present disclosure, the expression “at least one of A or B” or “at least one of A and/or B” may be interpreted as “at least one of A and B”.

In addition, in the present disclosure, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present disclosure may mean “for example”. Specifically, when indicated as “control information (PDCCH)”, it may mean that “PDCCH” is proposed as an example of the “control information”. In other words, the “control information” of the present disclosure is not limited to “PDCCH”, and “PDCCH” may be proposed as an example of the “control information”. In addition, when indicated as “control information (i.e., PDCCH)”, it may also mean that “PDCCH” is proposed as an example of the “control information”.

A technical feature described individually in one figure in the present disclosure may be individually implemented, or may be simultaneously implemented.

The technology described below may be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), and so on. The CDMA may be implemented with a radio technology, such as universal terrestrial radio access (UTRA) or CDMA-2000. The TDMA may be implemented with a radio technology, such as global system for mobile communications (GSM)/general packet ratio service (GPRS)/enhanced data rate for GSM evolution (EDGE). The OFDMA may be implemented with a radio technology, such as institute of electrical and electronics engineers (IEEE) 802.11 (Wi-Fi), IEEE 802.16 (WiMAX), IEEE 802.20, evolved UTRA (E-UTRA), and so on. IEEE 802.16m is an evolved version of IEEE 802.16e and provides backward compatibility with a system based on the IEEE 802.16e. The UTRA is part of a universal mobile telecommunication system (UMTS). 3rd generation partnership project (3GPP) long term evolution (LTE) is part of an evolved UMTS (E-UMTS) using the E-UTRA. The 3GPP LTE uses the OFDMA in a downlink and uses the SC-FDMA in an uplink. LTE-advanced (LTE-A) is an evolution of the LTE.

5G NR is a successive technology of LTE-A corresponding to a new Clean-slate type mobile communication system having the characteristics of high performance, low latency, high availability, and so on. 5G NR may use resources of all spectrum available for usage including low frequency bands of less than 1 GHz, middle frequency bands ranging from 1 GHz to 10 GHz, high frequency (millimeter waves) of 24 GHz or more, and so on.

For clarity in the description, the following description will mostly focus on LTE-A or 5G NR. However, technical features according to an embodiment of the present disclosure will not be limited only to this.

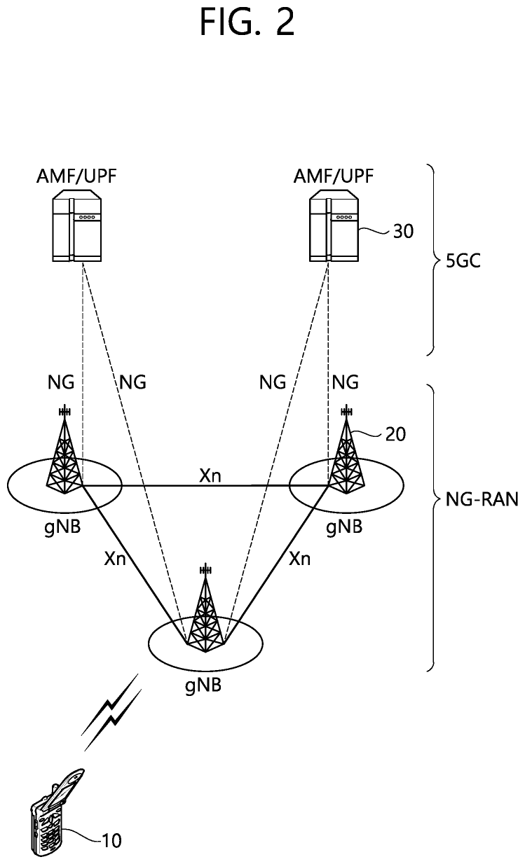

FIG. 2 shows a structure of an NR system, based on an embodiment of the present disclosure. The embodiment of FIG. 2 may be combined with various embodiments of the present disclosure.

Referring to FIG. 2, a next generation-radio access network (NG-RAN) may include a BS 20 providing a UE 10 with a user plane and control plane protocol termination. For example, the BS 20 may include a next generation-Node B (gNB) and/or an evolved-NodeB (eNB). For example, the UE 10 may be fixed or mobile and may be referred to as other terms, such as a mobile station (MS), a user terminal (UT), a subscriber station (SS), a mobile terminal (MT), wireless device, and so on. For example, the BS may be referred to as a fixed station which communicates with the UE 10 and may be referred to as other terms, such as a base transceiver system (BTS), an access point (AP), and so on.

The embodiment of FIG. 2 exemplifies a case where only the gNB is included. The BSs 20 may be connected to one another via Xn interface. The BS 20 may be connected to one another via 5th generation (5G) core network (5GC) and NG interface. More specifically, the BSs 20 may be connected to an access and mobility management function (AMF) 30 via NG- C interface, and may be connected to a user plane function (UPF) 30 via NG-U interface.

Layers of a radio interface protocol between the UE and the network can be classified into a first layer (layer 1, L1), a second layer (layer 2, L2), and a third layer (layer 3, L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer exchanges an RRC message between the UE and the BS.

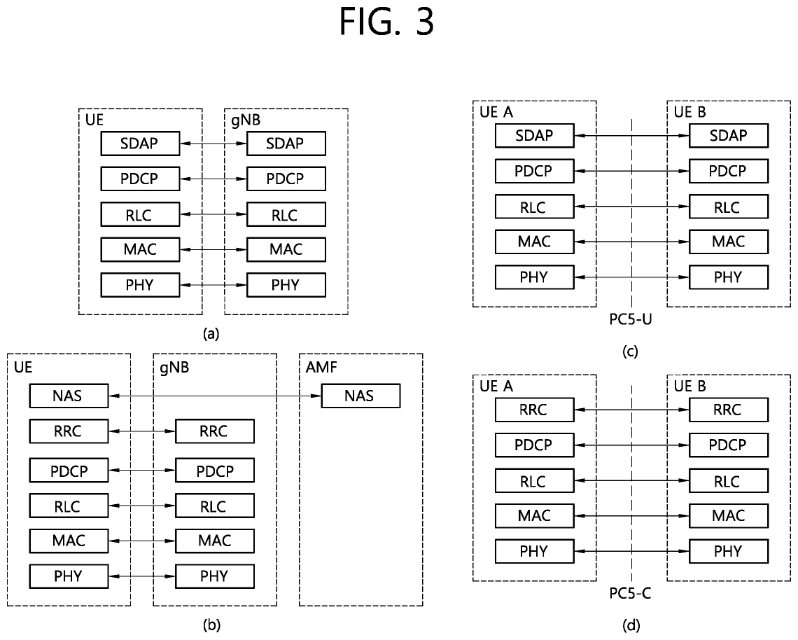

FIG. 3 shows a radio protocol architecture, based on an embodiment of the present disclosure. The embodiment of FIG. 3 may be combined with various embodiments of the present disclosure. Specifically, (a) of FIG. 3 shows a radio protocol stack of a user plane for Uu communication, and (b) of FIG. 3 shows a radio protocol stack of a control plane for Uu communication. (c) of FIG. 3 shows a radio protocol stack of a user plane for SL communication, and (d) of FIG. 3 shows a radio protocol stack of a control plane for SL communication.

Referring to FIG. 3, a physical layer provides an upper layer with an information transfer service through a physical channel. The physical layer is connected to a medium access control (MAC) layer which is an upper layer of the physical layer through a transport channel. Data is transferred between the MAC layer and the physical layer through the transport channel. The transport channel is classified according to how and with what characteristics data is transmitted through a radio interface.

Between different physical layers, i.e., a physical layer of a transmitter and a physical layer of a receiver, data are transferred through the physical channel. The physical channel is modulated using an orthogonal frequency division multiplexing (OFDM) scheme, and utilizes time and frequency as a radio resource.

The MAC layer provides services to a radio link control (RLC) layer, which is a higher layer of the MAC layer, via a logical channel. The MAC layer provides a function of mapping multiple logical channels to multiple transport channels. The MAC layer also provides a function of logical channel multiplexing by mapping multiple logical channels to a single transport channel. The MAC layer provides data transfer services over logical channels.

The RLC layer performs concatenation, segmentation, and reassembly of Radio Link Control Service Data Unit (RLC SDU). In order to ensure diverse quality of service (QoS) required by a radio bearer (RB), the RLC layer provides three types of operation modes, i.e., a transparent mode (TM), an unacknowledged mode (UM), and an acknowledged mode (AM). An AM RLC provides error correction through an automatic repeat request (ARQ).

A radio resource control (RRC) layer is defined only in the control plane. The RRC layer serves to control the logical channel, the transport channel, and the physical channel in association with configuration, reconfiguration and release of RBs. The RB is a logical path provided by the first layer (i.e., the physical layer or the PHY layer) and the second layer (i.e., a MAC layer, an RLC layer, a packet data convergence protocol (PDCP) layer, and a service data adaptation protocol (SDAP) layer) for data delivery between the UE and the network.

Functions of a packet data convergence protocol (PDCP) layer in the user plane include user data delivery, header compression, and ciphering. Functions of a PDCP layer in the control plane include control-plane data delivery and ciphering/integrity protection.

A service data adaptation protocol (SDAP) layer is defined only in a user plane. The SDAP layer performs mapping between a Quality of Service (QoS) flow and a data radio bearer (DRB) and QoS flow ID (QFI) marking in both DL and UL packets.

The configuration of the RB implies a process for specifying a radio protocol layer and channel properties to provide a particular service and for determining respective detailed parameters and operations. The RB can be classified into two types, i.e., a signaling RB (SRB) and a data RB (DRB). The SRB is used as a path for transmitting an RRC message in the control plane. The DRB is used as a path for transmitting user data in the user plane.

When an RRC connection is established between an RRC layer of the UE and an RRC layer of the E-UTRAN, the UE is in an RRC CONNECTED state, and, otherwise, the UE may be in an RRC IDLE state. In case of the NR, an RRC INACTIVE state is additionally defined, and a UE being in the RRC INACTIVE state may maintain its connection with a core network whereas its connection with the BS is released.

Data is transmitted from the network to the UE through a downlink transport channel. Examples of the downlink transport channel include a broadcast channel (BCH) for transmitting system information and a downlink-shared channel (SCH) for transmitting user traffic or control messages. Traffic of downlink multicast or broadcast services or the control messages can be transmitted on the downlink-SCH or an additional downlink multicast channel (MCH). Data is transmitted from the UE to the network through an uplink transport channel. Examples of the uplink transport channel include a random access channel (RACH) for transmitting an initial control message and an uplink SCH for transmitting user traffic or control messages.

Examples of logical channels belonging to a higher channel of the transport channel and mapped onto the transport channels include a broadcast channel (BCCH), a paging control channel (PCCH), a common control channel (CCCH), a multicast control channel (MCCH), a multicast traffic channel (MTCH), etc.

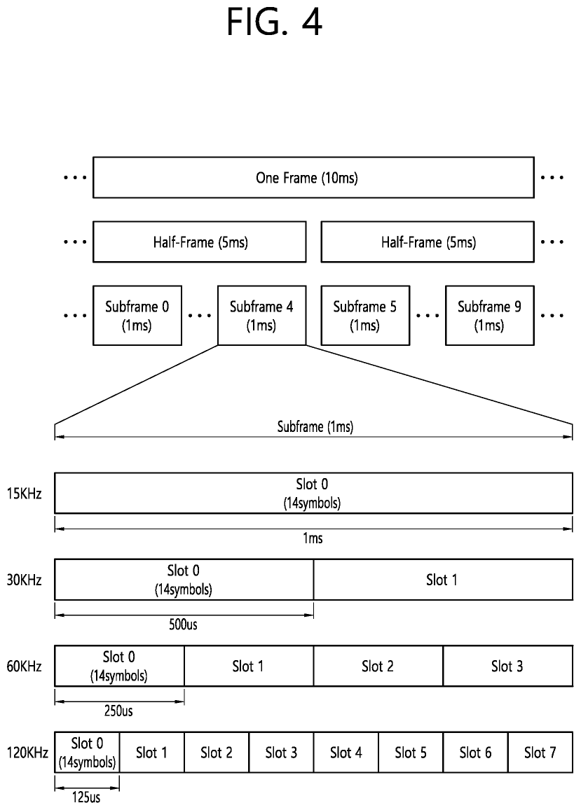

FIG. 4 shows a structure of a radio frame of an NR, based on an embodiment of the present disclosure. The embodiment of FIG. 4 may be combined with various embodiments of the present disclosure.

Referring to FIG. 4, in the NR, a radio frame may be used for performing uplink and downlink transmission. A radio frame has a length of 10 ms and may be defined to be configured of two half-frames (HFs). A half-frame may include five 1 ms subframes (SFs). A subframe (SF) may be divided into one or more slots, and the number of slots within a subframe may be determined based on subcarrier spacing (SCS). Each slot may include 12 or 14 OFDM(A) symbols according to a cyclic prefix (CP).

In case of using a normal CP, each slot may include 14 symbols. In case of using an extended CP, each slot may include 12 symbols. Herein, a symbol may include an OFDM symbol (or CP-OFDM symbol) and a Single Carrier-FDMA (SC-FDMA) symbol (or Discrete Fourier Transform-spread-OFDM (DFT-s-OFDM) symbol).

Table 1 shown below represents an example of a number of symbols per slot (N^{slot}_{symb}), a number slots per frame (N^{frame,u}ₛₗₒₜ), and a number of slots per subframe (N^{subframe,u}ₛₗₒₜ) based on an SCS configuration (u), in a case where a normal CP is used.

TABLE 1

| SCS (15*2^{u}) | N^{slot}_{symb} | N^{frame, u}ₛₗₒₜ | N^{subframe, u}ₛₗₒₜ |
|---|---|---|---|
| 15 KHz (u = 0) | 14 | 10 | 1 |
| 30 KHz (u = 1) | 14 | 20 | 2 |
| 60 KHz (u = 2) | 14 | 40 | 4 |
| 120 KHz (u = 3) | 14 | 80 | 8 |
| 240 KHz (u = 4) | 14 | 160 | 16 |

Table 2 shows an example of a number of symbols per slot, a number of slots per frame, and a number of slots per subframe based on the SCS, in a case where an extended CP is used.

TABLE 2

| SCS (15*2^{u}) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

In an NR system, OFDM(A) numerologies (e.g., SCS, CP length, and so on) between multiple cells being integrate to one UE may be differently configured. Accordingly, a (absolute time) duration (or section) of a time resource (e.g., subframe, slot or TTI) (collectively referred to as a time unit (TU) for simplicity) being configured of the same number of symbols may be differently configured in the integrated cells.

In the NR, multiple numerologies or SCSs for supporting diverse 5G services may be supported. For example, in case an SCS is 15 kHz, a wide area of the conventional cellular bands may be supported, and, in case an SCS is 30 kHz/60 kHz a dense-urban, lower latency, wider carrier bandwidth may be supported. In case the SCS is 60 kHz or higher, a bandwidth that is greater than 24.25 GHz may be used in order to overcome phase noise.

An NR frequency band may be defined as two different types of frequency ranges. The two different types of frequency ranges may be FR1 and FR2. The values of the frequency ranges may be changed (or varied), and, for example, the two different types of frequency ranges may be as shown below in Table 3. Among the frequency ranges that are used in an NR system, FR1 may mean a “sub 6 GHz range”, and FR2 may mean an “above 6 GHz range” and may also be referred to as a millimeter wave (mmW).

TABLE 3

| Frequency Range | Corresponding | |
|---|---|---|
| designation | frequency range | Subcarrier Spacing (SCS) |
| FR1 | 450 MHz-6000 MHz | 15, 30, 60 kHz |
| FR2 | 24250 MHz-52600 MHz | 60, 120, 240 kHz |

As described above, the values of the frequency ranges in the NR system may be changed (or varied). For example, as shown below in Table 4, FR1 may include a band within a range of 410 MHz to 7125 MHz. More specifically, FR1 may include a frequency band of 6 GHz (or 5850, 5900, 5925 MHz, and so on) and higher. For example, a frequency band of 6 GHz (or 5850, 5900, 5925 MHz, and so on) and higher being included in FR1 mat include an unlicensed band. The unlicensed band may be used for diverse purposes, e.g., the unlicensed band for vehicle-specific communication (e.g., automated driving).

TABLE 4

| Frequency Range | Corresponding | |
|---|---|---|
| designation | frequency range | Subcarrier Spacing (SCS) |
| FR1 | 410 MHz-7125 MHz | 15, 30, 60 kHz |
| FR2 | 24250 MHz-52600 MHz | 60, 120, 240 kHz |

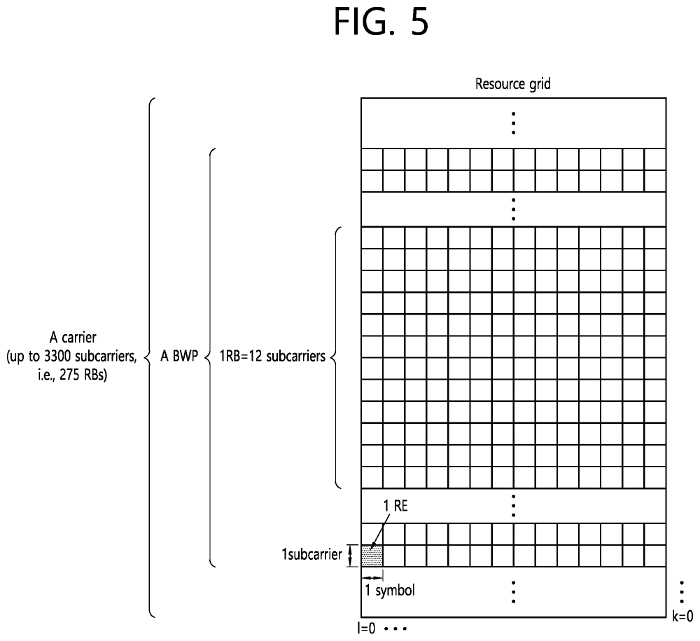

FIG. 5 shows a structure of a slot of an NR frame, based on an embodiment of the present disclosure. The embodiment of FIG. 5 may be combined with various embodiments of the present disclosure.

Referring to FIG. 5, a slot includes a plurality of symbols in a time domain. For example, in case of a normal CP, one slot may include 14 symbols. However, in case of an extended CP, one slot may include 12 symbols. Alternatively, in case of a normal CP, one slot may include 7 symbols. However, in case of an extended CP, one slot may include 6 symbols.

A carrier includes a plurality of subcarriers in a frequency domain. A Resource Block (RB) may be defined as a plurality of consecutive subcarriers (e.g., 12 subcarriers) in the frequency domain. A Bandwidth Part (BWP) may be defined as a plurality of consecutive (Physical) Resource Blocks ((P)RBs) in the frequency domain, and the BWP may correspond to one numerology (e.g., SCS, CP length, and so on). A carrier may include a maximum of N number BWPs (e.g., 5 BWPs). Data communication may be performed via an activated BWP. Each element may be referred to as a Resource Element (RE) within a resource grid and one complex symbol may be mapped to each element.

Hereinafter, a bandwidth part (BWP) and a carrier will be described.

The BWP may be a set of consecutive physical resource blocks (PRBs) in a given numerology. The PRB may be selected from consecutive sub-sets of common resource blocks (CRBs) for the given numerology on a given carrier

For example, the BWP may be at least any one of an active BWP, an initial BWP, and/or a default BWP. For example, the UE may not monitor downlink radio link quality in a DL BWP other than an active DL BWP on a primary cell (PCell). For example, the UE may not receive PDCCH, physical downlink shared channel (PDSCH), or channel state information—reference signal (CSI-RS) (excluding RRM) outside the active DL BWP. For example, the UE may not trigger a channel state information (CSI) report for the inactive DL BWP. For example, the UE may not transmit physical uplink control channel (PUCCH) or physical uplink shared channel (PUSCH) outside an active UL BWP. For example, in a downlink case, the initial BWP may be given as a consecutive RB set for a remaining minimum system information (RMSI) control resource set (CORESET) (configured by physical broadcast channel (PBCH)). For example, in an uplink case, the initial BWP may be given by system information block (SIB) for a random access procedure. For example, the default BWP may be configured by a higher layer. For example, an initial value of the default BWP may be an initial DL BWP. For energy saving, if the UE fails to detect downlink control information (DCI) during a specific period, the UE may switch the active BWP of the UE to the default BWP.

Meanwhile, the BWP may be defined for SL. The same SL BWP may be used in transmission and reception. For example, a transmitting UE may transmit an SL channel or an SL signal on a specific BWP, and a receiving UE may receive the SL channel or the SL signal on the specific BWP. In a licensed carrier, the SL BWP may be defined separately from a Uu BWP, and the SL BWP may have configuration signaling separate from the Uu BWP. For example, the UE may receive a configuration for the SL BWP from the BS/network. For example, the UE may receive a configuration for the Uu BWP from the BS/network. The SL BWP may be (pre-)configured in a carrier with respect to an out-of-coverage NR V2X UE and an RRC IDLE UE. For the UE in the RRC CONNECTED mode, at least one SL BWP may be activated in the carrier.

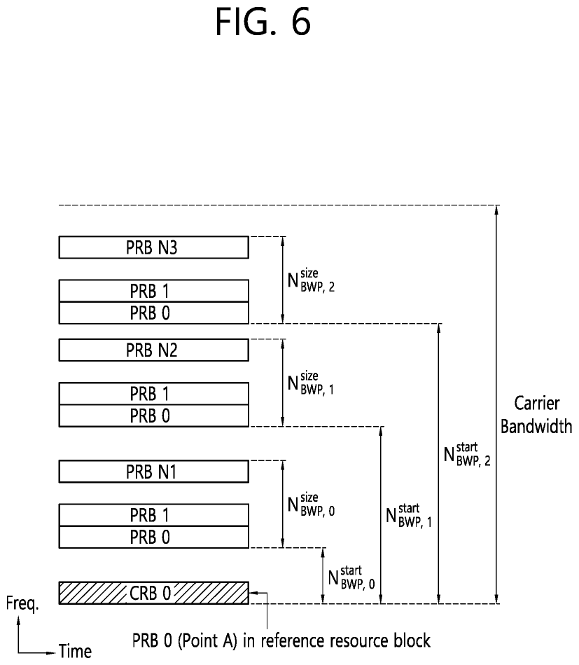

FIG. 6 shows an example of a BWP, based on an embodiment of the present disclosure. The embodiment of FIG. 6 may be combined with various embodiments of the present disclosure. It is assumed in the embodiment of FIG. 6 that the number of BWPs is 3.

Referring to FIG. 6, a common resource block (CRB) may be a carrier resource block numbered from one end of a carrier band to the other end thereof. In addition, the PRB may be a resource block numbered within each BWP. A point A may indicate a common reference point for a resource block grid.

The BWP may be configured by a point A, an offset N^{start}_{Bwp} from the point A, and a bandwidth N^{size}_{Bwp}. For example, the point A may be an external reference point of a PRB of a carrier in which a subcarrier 0 of all numerologies (e.g., all numerologies supported by a network on that carrier) is aligned. For example, the offset may be a PRB interval between a lowest subcarrier and the point A in a given numerology. For example, the bandwidth may be the number of PRBs in the given numerology.

Hereinafter, V2X or SL communication will be described.

A sidelink synchronization signal (SLSS) may include a primary sidelink synchronization signal (PSSS) and a secondary sidelink synchronization signal (SSSS), as an SL-specific sequence. The PSSS may be referred to as a sidelink primary synchronization signal (S-PSS), and the SSSS may be referred to as a sidelink secondary synchronization signal (S-SSS). For example, length-127 M-sequences may be used for the S-PSS, and length-127 gold sequences may be used for the S-SSS. For example, a UE may use the S-PSS for initial signal detection and for synchronization acquisition. For example, the UE may use the S-PSS and the S-SSS for acquisition of detailed synchronization and for detection of a synchronization signal ID.

A physical sidelink broadcast channel (PSBCH) may be a (broadcast) channel for transmitting default (system) information which must be first known by the UE before SL signal transmission/reception. For example, the default information may be information related to SLSS, a duplex mode (DM), a time division duplex (TDD) uplink/downlink (UL/DL) configuration, information related to a resource pool, a type of an application related to the SLSS, a subframe offset, broadcast information, or the like. For example, for evaluation of PSBCH performance, in NR V2X, a payload size of the PSBCH may be 56 bits including 24-bit cyclic redundancy check (CRC).

The S-PSS, the S-SSS, and the PSBCH may be included in a block format (e.g., SL synchronization signal (SS)/PSBCH block, hereinafter, sidelink-synchronization signal block (S-SSB)) supporting periodical transmission. The S-SSB may have the same numerology (i.e., SCS and CP length) as a physical sidelink control channel (PSCCH)/physical sidelink shared channel (PSSCH) in a carrier, and a transmission bandwidth may exist within a (pre-)configured sidelink (SL) BWP. For example, the S-SSB may have a bandwidth of 11 resource blocks (RBs). For example, the PSBCH may exist across 11 RBs. In addition, a frequency position of the S-SSB may be (pre-)configured. Accordingly, the UE does not have to perform hypothesis detection at frequency to discover the S-SSB in the carrier.

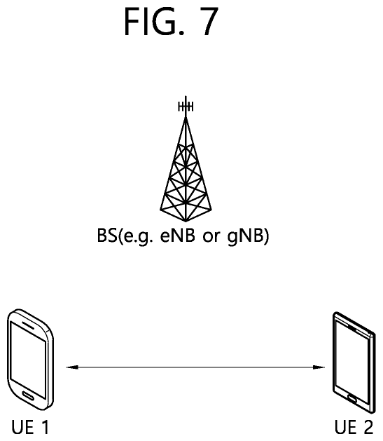

FIG. 7 shows a UE performing V2X or SL communication, based on an embodiment of the present disclosure. The embodiment of FIG. 7 may be combined with various embodiments of the present disclosure.

Referring to FIG. 7, in V2X or SL communication, the term ‘UE’ may generally imply a UE of a user. However, if a network equipment such as a BS transmits/receives a signal according to a communication scheme between UEs, the BS may also be regarded as a sort of the UE. For example, a UE 1 may be a first apparatus 100, and a UE 2 may be a second apparatus 200.

For example, the UE 1 may select a resource unit corresponding to a specific resource in a resource pool which implies a set of series of resources. In addition, the UE 1 may transmit an SL signal by using the resource unit. For example, a resource pool in which the UE 1 is capable of transmitting a signal may be configured to the UE 2 which is a receiving UE, and the signal of the UE 1 may be detected in the resource pool.

Herein, if the UE 1 is within a connectivity range of the BS, the BS may inform the UE 1 of the resource pool. Otherwise, if the UE 1 is out of the connectivity range of the BS, another UE may inform the UE 1 of the resource pool, or the UE 1 may use a pre-configured resource pool.

In general, the resource pool may be configured in unit of a plurality of resources, and each UE may select a unit of one or a plurality of resources to use it in SL signal transmission thereof

Hereinafter, resource allocation in SL will be described.

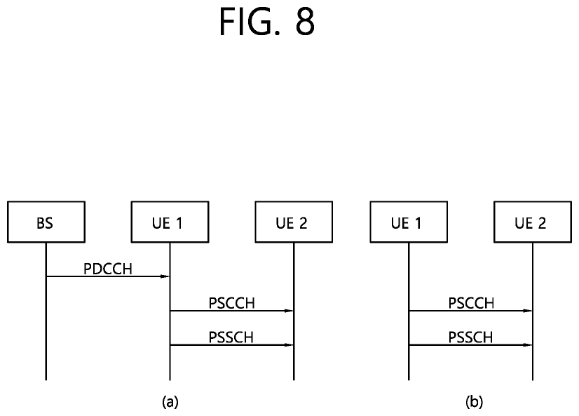

FIG. 8 shows a procedure of performing V2X or SL communication by a UE based on a transmission mode, based on an embodiment of the present disclosure. The embodiment of FIG. 8 may be combined with various embodiments of the present disclosure. In various embodiments of the present disclosure, the transmission mode may be called a mode or a resource allocation mode. Hereinafter, for convenience of explanation, in LTE, the transmission mode may be called an LTE transmission mode. In NR, the transmission mode may be called an NR resource allocation mode.

For example, (a) of FIG. 8 shows a UE operation related to an LTE transmission mode 1 or an LTE transmission mode 3. Alternatively, for example, (a) of FIG. 8 shows a UE operation related to an NR resource allocation mode 1. For example, the LTE transmission mode 1 may be applied to general SL communication, and the LTE transmission mode 3 may be applied to V2X communication.

For example, (b) of FIG. 8 shows a UE operation related to an LTE transmission mode 2 or an LTE transmission mode 4. Alternatively, for example, (b) of FIG. 8 shows a UE operation related to an NR resource allocation mode 2.

Referring to (a) of FIG. 8, in the LTE transmission mode 1, the LTE transmission mode 3, or the NR resource allocation mode 1, a BS may schedule an SL resource to be used by the UE for SL transmission. For example, the BS may perform resource scheduling to a UE 1 through a PDCCH (e.g., downlink control information (DCI)) or RRC signaling (e.g., Configured Grant Type 1 or Configured Grant Type 2), and the UE 1 may perform V2X or SL communication with respect to a UE 2 according to the resource scheduling. For example, the UE 1 may transmit a sidelink control information (SCI) to the UE 2 through a physical sidelink control channel (PSCCH), and thereafter transmit data based on the SCI to the UE 2 through a physical sidelink shared channel (PS SCH).

Referring to (b) of FIG. 8, in the LTE transmission mode 2, the LTE transmission mode 4, or the NR resource allocation mode 2, the UE may determine an SL transmission resource within an SL resource configured by a BS/network or a pre-configured SL resource. For example, the configured SL resource or the pre-configured SL resource may be a resource pool. For example, the UE may autonomously select or schedule a resource for SL transmission. For example, the UE may perform SL communication by autonomously selecting a resource within a configured resource pool. For example, the UE may autonomously select a resource within a selective window by performing a sensing and resource (re)selection procedure. For example, the sensing may be performed in unit of subchannels. In addition, the UE 1 which has autonomously selected the resource within the resource pool may transmit the SCI to the UE 2 through a PSCCH, and thereafter may transmit data based on the SCI to the UE 2 through a PSSCH.

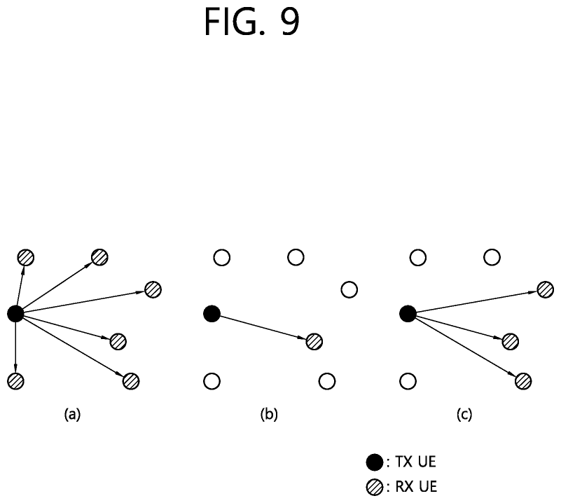

FIG. 9 shows three cast types, based on an embodiment of the present disclosure. The embodiment of FIG. 9 may be combined with various embodiments of the present disclosure. Specifically, (a) of FIG. 9 shows broadcast-type SL communication, (b) of FIG. 9 shows unicast type-SL communication, and (c) of FIG. 9 shows groupcast-type SL communication. In case of the unicast-type SL communication, a UE may perform one-to-one communication with respect to another UE. In case of the groupcast-type SL transmission, the UE may perform SL communication with respect to one or more UEs in a group to which the UE belongs. In various embodiments of the present disclosure, SL groupcast communication may be replaced with SL multicast communication, SL one-to-many communication, or the like.

Hereinafter, a sidelink control information (SCI) will be described.

Control information transmitted by a BS to a UE through a PDCCH may be referred to as downlink control information (DCI), whereas control information transmitted by the UE to another UE through a PSCCH may be referred to as SCI. For example, the UE may know in advance a start symbol of the PSCCH and/or the number of symbols of the PSCCH, before decoding the PSCCH. For example, the SCI may include SL scheduling information. For example, the UE may transmit at least one SCI to another UE to schedule the PSSCH. For example, one or more SCI formats may be defined.

For example, a transmitting UE may transmit the SCI to a receiving UE on the PSCCH. The receiving UE may decode one SCI to receive the PSSCH from the transmitting UE.

For example, the transmitting UE may transmit two consecutive SCIs (e.g., 2-stage SCI) to the receiving UE on the PSCCH and/or the PSSCH. The receiving UE may decode the two consecutive SCIs (e.g., 2-stage SCI) to receive the PSSCH from the transmitting UE. For example, if SCI configuration fields are divided into two groups in consideration of a (relatively) high SCI payload size, an SCI including a first SCI configuration field group may be referred to as a first SCI or a 1^{st} SCI, and an SCI including a second SCI configuration field group may be referred to as a second SCI or a 2^{nd} SCI. For example, the transmitting UE may transmit the first SCI to the receiving UE through the PSCCH. For example, the transmitting UE may transmit the second SCI to the receiving UE on the PSCCH and/or the PSSCH. For example, the second SCI may be transmitted to the receiving UE through an (independent) PSCCH, or may be transmitted in a piggyback manner together with data through the PSS CH. For example, two consecutive SCIs may also be applied to different transmissions (e.g., unicast, broadcast, or groupcast).

For example, the transmitting UE may transmit the entirety or part of information described below to the receiving UE through the SCI. Herein, for example, the transmitting UE may transmit the entirety or part of the information described below to the receiving UE through the first SCI and/or the second SCI.
PSSCH and/or PSCCH related resource allocation information, e.g., the number/positions of time/frequency resources, resource reservation information (e.g., period), and/or
SL CSI report request indicator or SL (L1) RSRP (and/or SL (L1) RSRQ and/or SL (L1) RSSI) report request indicator, and/or
SL CSI transmission indicator (or SL (L1) RSRP (and/or SL (L1) RSRQ and/or SL (L1) RSSI) information transmission indicator)) (on PSSCH), and/or
MCS information, and/or
Transmit power information, and/or
L1 destination ID information and/or L1 source ID information, and/or
SL HARQ process ID information, and/or
New data indicator (NDI) information, and/or
Redundancy version (RV) information, and/or
(Transmission traffic/packet related) QoS information, e.g., priority information, and/or
SL CSI-RS transmission indicator or information on the number of (to-be-transmitted) SL CSI-RS antenna ports, and/or
Location information of a transmitting UE or location (or distance region) information of a target receiving UE (for which SL HARQ feedback is requested), and/or
Reference signal (e.g., DMRS, etc.) related to channel estimation and/or decoding of data to be transmitted through a PSSCH, e.g., information related to a pattern of a (time-frequency) mapping resource of DMRS, rank information, antenna port index information

For example, the first SCI may include information related to channel sensing. For example, the receiving UE may decode the second SCI by using a PSSCH DMRS. A polar code used in a PDCCH may be applied to the second SCI. For example, in a resource pool, a payload size of the first SCI may be identical for unicast, groupcast, and broadcast. After decoding the first SCI, the receiving UE does not have to perform blind decoding of the second SCI. For example, the first SCI may include scheduling information of the second SCI.

Hereinafter, power saving will be described.

For the power saving method of the UE, UE adaptation for traffic and power consumption characteristics, adaptation according to change in frequency/time, adaption to the antenna(s), adaptation to discontinuous reception (DRX) configurations, adaptation to UE processing capability, adaptation for reduction of PDCCH monitoring/decoding, power saving signal/channel/procedure for triggering adaptation for UE power consumption, power consumption reduction during RRM measurement, etc. may be considered.

Hereinafter, as a method for implementing UE power saving, discontinuous reception (DRX) will be described.

The procedure of the UE related to the DRX may be summarized as Table 5.

TABLE 5

| | Type of signals | UE procedure |
|---|---|---|
| Step 1 | RRC signalling | Receive DRX configuration |
| | (MAC-CellGroupConfig) | information |
| Step 2 | MAC CE ((Long) DRX | Receive DRX command |
| | command MAC CE) | |
| Step 3 | | Monitor a PDCCH during an |
| | | on-duration of a DRX cycle |

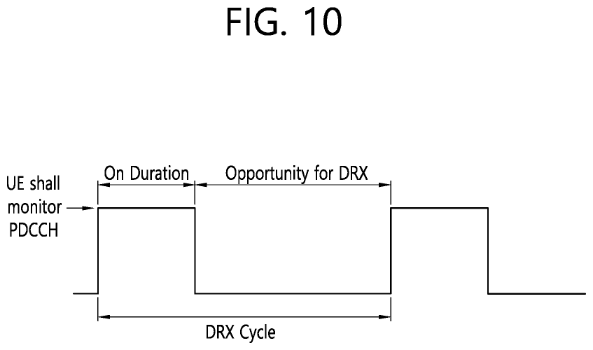

FIG. 10 shows an example of a DRX cycle, based on an embodiment of the present disclosure. The embodiment of FIG. 10 may be combined with various embodiments of the present disclosure.

Referring to FIG. 10, the UE uses discontinuous reception (DRX) in an RRC IDLE state and an RRC INACTIVE state in order to reduce power consumption. If the DRX is configured, the UE performs a DRX operation according to DRX configuration information. The UE operating as the DRX repeatedly turns its reception performance ON and OFF.

For example, if the DRX is configured, the UE attempts to receive a PDCCH, which is a downlink channel, only in a predetermined time period, and does not attempt to receive a PDCCH in the remaining time period. The time period during which the UE should attempt to receive the PDCCH is referred to as an on-duration, and the on-duration is defined once per DRX cycle.

The UE may receive DRX configuration information from the gNB through RRC signaling and operate as DRX through a reception of the (long) DRX command MAC CE.

The DRX configuration information may be included in MAC-CellGroupConfig. The MAC-CellGroupConfig IE is used to configure MAC parameters for a cell group, including DRX.

The DRX Command MAC CE or the long DRX Command MAC CE is identified by a MAC PDU subheader with LCID. It has a fixed size with zero bits.

Table 6 shows an example of values of LCID for DL-SCH.

TABLE 6

| Index | LCID values |
|---|---|
| 111011 | Long DRX Command |
| 111100 | DRX Command |

The PDCCH monitoring operation of the UE is controlled by DRX and bandwidth adaptation (BA). Meanwhile, If DRX is configured, the UE does not have to continuously monitor a PDCCH. Meanwhile, DRX is characterized by the following.
On-duration: duration that the UE waits for, after waking up, to receive a PDCCH. If the UE successfully decodes a PDCCH, the UE stays awake and starts an inactivity timer.
Inactivity timer: duration that the UE waits to successfully decode a PDCCH, from the last successful decoding of a PDCCH, failing which it may go back to sleep. The UE shall restart the inactivity timer after a single successful decoding of a PDCCH for the first transmission only (i.e., not for retransmissions).
Retransmission timer: duration until a retransmission may be expected;
Cycle: specifies the periodic repetition of the on-duration followed by a possible period of inactivity.

Next, DRX described in the MAC layer will be described. The MAC entity used below may be expressed as a UE or a MAC entity of the UE.

The MAC entity may be configured by RRC with a DRX functionality that controls the UE's PDCCH monitoring activity for the MAC entity's C-RNTI, CS-RNTI, TPC-PUCCH-RNTI, TPC-PUSCH-RNTI, and TPC-SRS-RNTI. When using DRX operation, the MAC entity shall also monitor a PDCCH. When in RRC CONNECTED, if DRX is configured, the MAC entity may monitor a PDCCH discontinuously using the DRX operation. Otherwise, the MAC entity shall monitor a PDCCH continuously.

RRC controls DRX operation by configuring parameters related to DRX configuration information.

If a DRX cycle is configured, an active time includes the time while:
drx-onDurationTimer or drx-InactivityTimer or drx-RetransmissionTimerDL or drx-RetransmissionTimer UL or ra-ContentionResolutionTimer is running; or
a scheduling request is sent on a PUCCH and is pending; or
a PDCCH indicating a new transmission addressed to the C-RNTI of the MAC entity has not been received after successful reception of a random access response for the random access preamble not selected by the MAC entity among the contention-based random access preamble.

If DRX is configured, the MAC entity shall:

1>if a MAC PDU is transmitted in a configured uplink grant:

2>start the drx-HARQ-RTT-TimerUL for the corresponding HARQ process immediately after the first repetition of the corresponding PUSCH transmission;

2>stop the drx-RetransmissionTimerUL for the corresponding HARQ process.

1>if a drx-HARQ-RTT-TimerDL expires:

2>if the data of the corresponding HARQ process was not successfully decoded:

3>start the drx-RetransmissionTimerDL for the corresponding HARQ process.

1>if a drx-HARQ-RTT-TimerUL expires:

2>start the drx-RetransmissionTimerUL for the corresponding HARQ process.

1>if a DRX Command MAC CE or a Long DRX Command MAC CE is received:

2>stop drx-onDurationTimer;

2>stop drx-InactivityTimer

1>if drx-InactivityTimer expires or a DRX Command MAC CE is received:

2>if the Short DRX cycle is configured:

3>start or restart drx-ShortCycleTimer;

3>use the Short DRX Cycle.

2>else:

3>use the Long DRX cycle.

1>if drx-ShortCycleTimer expires:

2>use the Long DRX cycle.

1>if a Long DRX Command MAC CE is received:

2>stop drx-ShortCycleTimer;

2>use the Long DRX cycle.

1>if the Short DRX Cycle is used, and [(SFN×10)+subframe number] modulo (drx-ShortCycle)=(drx-StartOffset) modulo (drx-ShortCycle); or

1>if the Long DRX Cycle is used, and [(SFN×10)+subframe number] modulo (drx-LongCycle)=drx-StartOffset:

2>if drx-SlotOffset is configured:

3>start drx-onDurationTimer after drx-SlotOffset.

2>else:

3>start drx-onDurationTimer.

1>if the MAC entity is in Active Time:

2>monitor the PDCCH;

2>if the PDCCH indicates a DL transmission or if a DL assignment has been configured:

3>start the drx-HARQ-RTT-TimerDL for the corresponding HARQ process immediately after the corresponding PUCCH transmission;

3>stop the drx-RetransmissionTimerDL for the corresponding HARQ process.

2>if the PDCCH indicates a UL transmission:

3>start the drx-HARQ-RTT-TimerUL for the corresponding HARQ process immediately after the first repetition of the corresponding PUSCH transmission;

3>stop the drx-RetransmissionTimerUL for the corresponding HARQ process.

2>if the PDCCH indicates a new transmission (DL or UL):

3>start or restart drx-InactivityTimer.

1>else (i.e., not part of the Active Time):

2>not transmit type-0-triggered SRS.

1>if CQI masking (cqi-Mask) is setup by upper layers:

2>if drx-onDurationTimer is not running:

3>not report CSI on PUCCH.

1>else:

2>if the MAC entity is not in Active Time:

3>not report CSI on PUCCH.

Regardless of whether the MAC entity is monitoring PDCCH or not, the MAC entity transmits HARQ feedback and type-1-triggered SRS when such is expected.

The MAC entity needs not to monitor the PDCCH if it is not a complete PDCCH occasion (e.g., the Active Time starts or expires in the middle of a PDCCH occasion).

In the present disclosure, the term “configuration/configured or definition/defined” may be interpreted as being (pre-)configured from the base station or the network (through predefined signaling (e.g., SIB, MAC signaling, RRC signaling)). For example, “A may be configured” may include “that the base station or the network (pre-)configures/defines or informs A to the UE”. Alternatively, the term “configuration/configured or definition/defined” may be interpreted as being pre-configured or pre-defined in the system. For example, “A may be configured” may include “that A is pre-configured/defined in the system”.

Meanwhile, in order to reduce power consumption of the UE in SL communication, the UE may not always monitor a transmission channel. That is, the UE may detect an SL signal or channel to be received by monitoring a transmission channel only if reception of a PSCCH and/or PS SCH is required, and the UE may perform decoding for the SL signal or channel.

Meanwhile, a DRX cycle may include (i) an active time when the UE monitors a transmission channel in an awake mode and, if necessary, detects/decodes an SL channel, and (ii) an inactive time when the UE is in a sleep mode (i.e., the UE does not need to monitor a channel).

For example, the active time may include (i) an OnDurationTimer duration in which the UE should be awake at the beginning of the DRX cycle, (ii) an InActivityTimer duration in which the UE should be additionally awake due to a high possibility of transmission of an additional SL signal or channel by other UE(s), after the OnDurationTimer expires, (iii) a RetransmissionTimer duration in which the UE should be additionally awake due to a high possibility of additional retransmission by another UE, after a certain transmission, etc.

For example, the inactive time may be all durations except for the active time within a DRX cycle representing an entire DRX duration. In particular, for example, the inactive time may include a HARQ-RTT-Timer duration configured to secure a processing time related to HARQ-based retransmission and a time required for retransmission.

For example, according to the length of a DRX cycle, the DRX cycle may include (i) a ‘DRX long cycle’ with a relatively long cycle length and (ii) a ‘DRX short cycle’ with a relatively short cycle length. For example, the start of the DRX long cycle and the DRX short cycle may be expressed as an offset value with respect to a reference timing. Herein, for example, the offset value may be StartOffset expressed as the number of subframe units. For example, the offset value may be SlotOffset expressed as the number of slot units.

Meanwhile, in order to ensure communication between UEs performing the SL DRX operation, SL DRX cycles and active times need to be aligned among the UEs. To this end, for example, the TX UE may transmit an SL DRX configuration to the RX UE. For example, if a connection is established between the base station and the TX UE, the base station may transmit an SL DRX configuration to the TX UE, and the TX UE may transmit the SL DRX configuration to the RX UE. Meanwhile, in the SL DRX operation, an active time may be changed by a timer. In this case, if the TX UE transmits a configuration for the timer to the RX UE whenever the configuration for the timer is changed, signaling overhead may increase. Therefore, in order to reduce signaling overhead, it is necessary to propose a method for adjusting an active time by the TX UE and the RX UE based on a predefined (implicit) rule.

Based on various embodiments of the present disclosure, a method for the UE to perform SL communication based on DRX and a device supporting the same are proposed. In the present disclosure, an ON duration may refer to an active time, and an OFF duration may refer to a time other than the active time (i.e., inactive time).

For example, the UE may identify/determine DCI or SCI to be detected and decoded through channel monitoring in an ON duration within a DRX cycle in SL communication, based on an identifier included in a DCI field or an SCI field. Herein, for example, the identifier may include at least one of a source ID, a destination ID, a zone ID, and/or a UE ID. For example, a method in which the UE identifies/determines DCI or SCI may be used together with a method in which the UE distinguishes a configuration for a dynamic grant (DG) resource or a configuration for a configured grant (CG) resource through SL RNTI detection or SL-CS- RNTI detection. For example, a method in which the UE identifies/determines DCI or SCI may be used independently of a method in which the UE distinguishes a configuration for a DG resource or a configuration for a CG resource through SL RNTI detection or SL-CS-RNTI detection.

For example, if the UE performing the DRX operation detects the identifier related to data to be received within an OnDurationTimer period, the UE may configure/start InactivityTimer to enable detection of additional data transmission related to the identifier for a specific time (e.g., short time) after OnDurationTimer expires. For example, the UE may configure/start RetransmissionTimer to enable detection of retransmission. Herein, for example, the value of InactivityTimer and/or the value of RetransmissionTimer may be pre-configured for the UE. For example, the base station/network may transmit information related to the value of InactivityTimer and/or information related to the value of RetransmissionTimer to the UE. For example, the value of InactivityTimer and/or the value of RetransmissionTimer may be pre-configured for the UE by a higher layer. For example, the higher layer of the UE may transfer information related to the value of InactivityTimer and/or information related to the value of RetransmissionTimer to a lower layer of the UE. For example, the higher layer of the UE may include an application layer and/or a V2X layer. For example, the lower layer of the UE may include at least one of an L1 layer, an L2 layer, and/or an L3 layer. For example, the TX UE may autonomously select/configure/determine the value of InactivityTimer and/or the value of RetransmissionTimer in consideration of a time interval between resources used for transmission. As described above, if the TX UE adaptively selects/configures/determines the value of InactivityTimer and/or the value of RetransmissionTimer autonomously based on the time interval between transmission resources used by the TX UE, the UE performing DRX-based communication may select/configure/determine the value of InactivityTimer and/or the value of RetransmissionTimer in the following manner.

For example, if a time interval between a plurality of resources within one DG resource or one mode-2 dynamic resource is less than (or less than or equal to) a threshold, the UE may select/configure/determine the value of InactivityTimer and/or the value of RetransmissionTimer to include all timings for the plurality of resources. For example, for a CG resource or a mode-2 SPS resource, if a time interval between a plurality of resources within one CG occasion or one SPS occasion is less than (or less than or equal to) a threshold, the UE may select/configure/determine the value of InactivityTimer and/or the value of RetransmissionTimer to include all timings for the plurality of resources within one CG occasion or one SPS occasion.

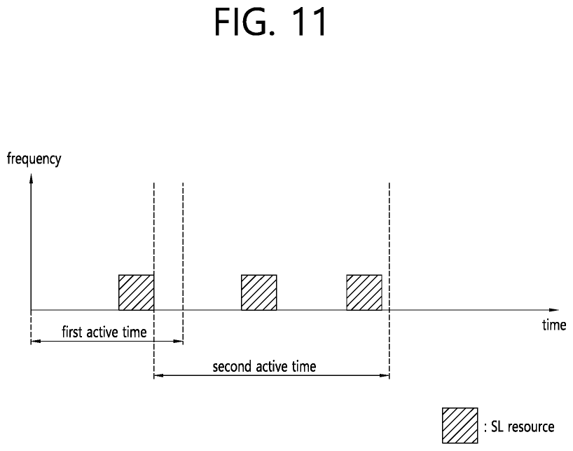

FIG. 11 shows a method for determining, by a UE, a timer value to include all timings of a plurality of resources if a time interval between the plurality of resources is less than (or less than or equal to) a threshold, based on an embodiment of the present disclosure. The embodiment of FIG. 11 may be combined with various embodiments of the present disclosure.

In the embodiment of FIG. 11, it is assumed that an SL resource is within a first active time and a time interval between a plurality of resources is less than (or less than or equal to) a threshold. In this case, the TX UE may determine a timer value (e.g., the value of InactivityTimer and/or the value of RetransmissionTimer) to include all timings for the plurality of resources, and the TX UE may start the timer. In the embodiment of FIG. 11, a time while the timer is running may be referred to as a second active time. For example, the RX UE that has decoded SCI transmitted by the TX UE based on the SL resource within the first active time may determine the time domain of a plurality of resources. Accordingly, the RX UE may determine that the time interval between the plurality of resources is less than (or less than or equal to) the threshold, and the RX UE may determine a timer value (e.g., the value of InactivityTimer and/or the value of RetransmissionTimer) to include all timings for the plurality of resources. In addition, the RX UE may start the timer. Through this, based on the implicit rule, the active time and/or the inactive time can be aligned between the TX UE and the RX UE.

For example, if a time interval between a plurality of resources within one DG resource or one mode-2 dynamic resource is greater than (or greater than or equal to) a threshold, the UE may select/configure/determine the value of InactivityTimer and/or the value of RetransmissionTimer to include timing for only one resource among the plurality of resources. For example, for a CG resource or a mode-2 SPS resource, if a time interval between a plurality of resources within one CG occasion or one SPS occasion is greater than (or greater than or equal to) a threshold, the UE may select/configure/determine the value of InactivityTimer and/or the value of RetransmissionTimer to include timing for only one resource among the plurality of resources within one CG occasion or one SPS occasion. In this case, during the time interval between the plurality of resources, a DRX duration may be set to an OFF duration.

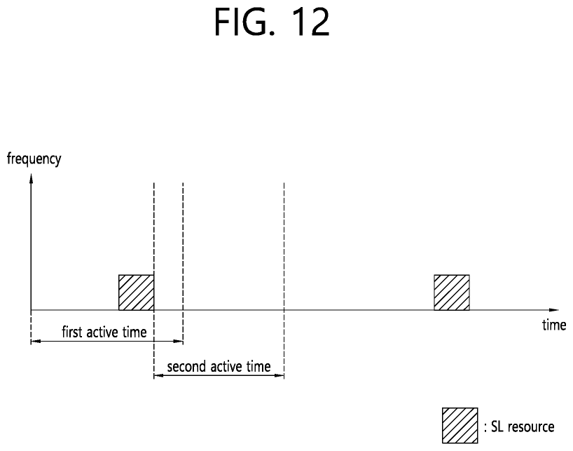

FIG. 12 shows a method for determining, by a UE, a timer to include timing for only one resource among a plurality of resources if a time interval between the plurality of resources is greater than (or greater than or equal to) a threshold, based on an embodiment of the present disclosure. The embodiment of FIG. 12 may be combined with various embodiments of the present disclosure.

In the embodiment of FIG. 12, it is assumed that an SL resource is within a first active time and a time interval between a plurality of resources is greater than (or greater than or equal to) a threshold. In this case, the TX UE may determine a timer value (e.g., the value of InactivityTimer and/or the value of RetransmissionTimer) to include timing for only one resource among the plurality of resources, and the TX UE may start the timer. In the embodiment of FIG. 12, a time while the timer is running may be referred to as a second active time. For example, the RX UE that has decoded SCI transmitted by the TX UE based on the SL resource within the first active time may determine the time domain of a plurality of resources. Accordingly, the RX UE may determine that the time interval between the plurality of resources is greater than (or greater than or equal to) the threshold, and the RX UE may determine a timer value (e.g., the value of InactivityTimer and/or the value of RetransmissionTimer) to include timing for only one resource among the plurality of resources. In addition, the RX UE may start the timer. Through this, based on the implicit rule, the active time and/or the inactive time can be aligned between the TX UE and the RX UE.

In the present disclosure, the threshold may be predefined for the UE. In the present disclosure, the threshold may be configured or pre-configured for the UE by the base station/network. For example, the base station/network may transmit information related to the threshold to the UE. In the present disclosure, the threshold may be configured by a higher layer of the UE.

In the present disclosure, the DG resource may be resource(s) configured/allocated by the base station to the UE through DCI. In the present disclosure, the CG resource may be (periodic) resource(s) configured/allocated by the base station to the UE through DCI and/or an RRC message. In the present disclosure, the mode-2 dynamic resource may be resource(s) selected by the UE within a resource pool based on sensing. In the present disclosure, the mode-2 SPS resource may be (periodic) resource(s) selected by the UE within a resource pool based on sensing.

For example, if a period value of the CG resource or a reservation period value of the mode- 2 SPS resource is less than a threshold (e.g., a pre-configured value of InactivityTimer and/or a pre-configured value of RetransmissionTimer), the UE may select/configure/determine a value of InactivityTimer and/or a value of RetransmissionTimer as the pre-configured value of InactivityTimer and/or the pre-configured value of RetransmissionTimer. For example, if a period value of the CG resource or a reservation period value of the mode-2 SPS resource is greater than a threshold (e.g., a pre-configured value of InactivityTimer and/or a pre-configured value of RetransmissionTimer), the UE may select/configure/determine a value of InactivityTimer and/or a value of RetransmissionTimer as the period value of the CG resource or the reservation period value of the mode-2 SPS resource. That is, the UE may select/configure/determine the maximum value, among the pre-configured value of InactivityTimer and/or the pre-configured value of RetransmissionTimer and the reservation period value or the period value of the SL communication resource, as the final value of InactivityTimer and/or the final value of RetransmissionTimer.

For example, if SL HARQ feedback is enabled, a time interval between (i) SL transmission through a certain transmission resource by the TX UE and (ii) PSFCH transmission including HARQ feedback for the SL transmission by the RX UE may be less than a threshold. In this case, the UE (e.g., RX UE) may select/configure/determine the value of InactivityTimer and/or the value of RetransmissionTimer to a value greater than or equal to the time interval after receiving a message related to the SL transmission.

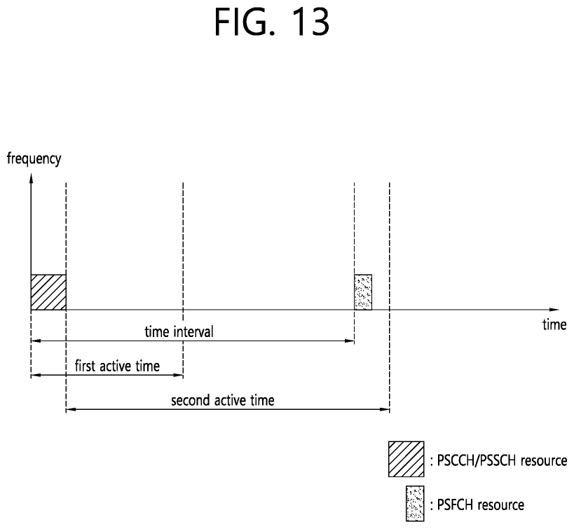

FIG. 13 shows a method for determining, by a UE, a timer value to include timing for a PSFCH resource if a time interval between a PSCCH/PSSCH resource and the PSFCH resource is less than a threshold, based on an embodiment of the present disclosure. The embodiment of FIG. 13 may be combined with various embodiments of the present disclosure.

In the embodiment of FIG. 13, it is assumed that a PSCCH/PSSCH resource is within a first active time and a time interval between the PSCCH/PSSCH resource and a PSFCH resource is less than a threshold. In this case, the TX UE may determine a timer value (e.g., the value of InactivityTimer and/or the value of RetransmissionTimer) to include timing for the PSFCH resource, and the TX UE may start the timer. In the embodiment of FIG. 13, a time while the timer is running may be referred to as a second active time. For example, the RX UE that has decoded SCI transmitted by the TX UE based on the PSCCH/PSSCH resource within the first active time may determine a time interval between the PSCCH/PSSCH resource and the PSFCH resource. Accordingly, the RX UE may determine that the time interval between the PSCCH/PSSCH resource and the PSFCH resource is less than the threshold, and the RX UE may determine a timer value (e.g., the value of InactivityTimer and/or the value of RetransmissionTimer) to include timing for the PSFCH resource. In addition, the RX UE may start the timer. Through this, based on the implicit rule, the active time and/or the inactive time can be aligned between the TX UE and the RX UE.

For example, if SL HARQ feedback is enabled, a time interval between (i) SL transmission through a certain transmission resource by the TX UE and (ii) PSFCH transmission including HARQ feedback for the SL transmission by the RX UE may be greater than a threshold. In this case, the UE (e.g., RX UE) may select/configure/determine a value of HARQRTTTimer to a value greater than or equal to the time interval after receiving a message related to the SL transmission.

For example, the TX UE performing mode 1-based SL communication may transmit a PSCCH/PSSCH to the RX UE, and the TX UE may receive SL HARQ feedback information from the RX UE through a PSFCH related to the PSCCH/PSSCH. Thereafter, the TX UE may report the SL HARQ feedback information to the base station through a PUCCH related to the PSFCH. In this case, after the TX UE receives the PSFCH from the RX UE, the TX UE may select/configure/determine a value of DL HARQRTTTimer to a value greater than or equal to a time interval between (i) the PSFCH resource and (ii) the PUCCH resource for reporting the SL HARQ feedback information to the base station.

For example, if the RX UE successfully decodes a TB received from the TX UE, the RX UE may transmit SL HARQ ACK information to the TX UE. In this case, the RX UE may stop InactivityTimer and/or RetransmissionTimer and/or OnDurationTimer described above, and the RX UE may transition the DRX state to the OFF duration within the DRX cycle.

For example, the TX UE may no longer have data that can be transmitted, or the TX UE may no longer have transmission resources available for transmission. For example, if the number of transmissions of the TX UE reaches the maximum number of retransmissions, the TX UE may no longer have transmission resources available for transmission. In the above case, the TX UE may stop all ON durations in the DRX cycle and notify the RX UE to transition to the OFF duration. For example, information related to DRX ON/OFF duration transition may be transmitted from the TX UE to the RX UE through SCI, MAC CE, or SL RRC signaling.

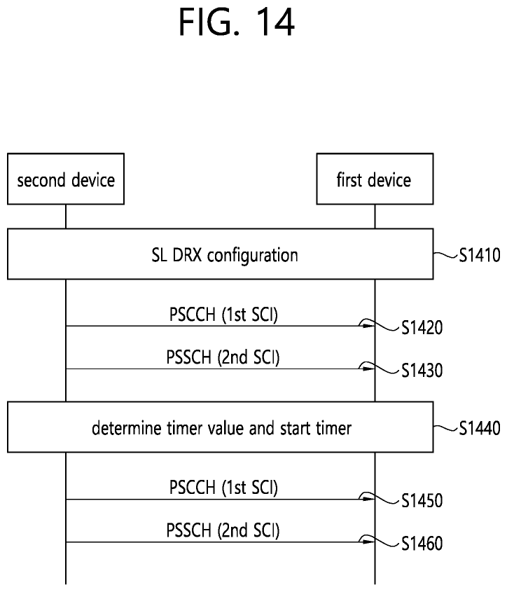

FIG. 14 shows a procedure for determining a timer value by a first device and a second device, based on an embodiment of the present disclosure. The embodiment of FIG. 14 may be combined with various embodiments of the present disclosure.

In the embodiment of FIG. 14, in step S1410, an SL DRX configuration may be configured between the first device and the second device. For example, the first device may transmit the SL DRX configuration to the second device. For example, the SL DRX configuration may include information related to an active time and information related to a DRX cycle.

In step S1420, the first device may transmit first SCI through a PSCCH. For example, the first SCI may include information for scheduling a PSSCH and/or second SCI.

In step S1430, the first device may transmit the second SCI through the PSSCH. Additionally, for example, the UE may transmit data (e.g., MAC PDU or TB) through the PSS CH.

In step S1440, the first device and the second device may determine a value of a timer based on various embodiments of the present disclosure. Additionally, the first device and the second device may start the timer.

In step S1450, the first device may transmit first SCI through a PSCCH based on the SL DRX configuration. For example, the first SCI may include information for scheduling a PSSCH and/or second SCI.

In step S1460, the first device may transmit the second SCI through the PSSCH based on the SL DRX configuration. Additionally, for example, the UE may transmit data (e.g., MAC PDU or TB) through the PSSCH based on the SL DRX configuration.

Based on various embodiments of the present disclosure, the active time and/or the inactive time may be aligned between the TX UE and the RX UE based on the implicit rule. Therefore, signaling overhead can be reduced compared to a case in which the TX UE transmits a timer configuration to the RX UE whenever the timer configuration is changed.

In the present disclosure, a method for adaptively configuring, by the UE operating in DRX in SL communication, timer(s) related to the DRX ON/OFF duration based on transmission resources and reception conditions and a device supporting the same are proposed.

Based on various embodiments of the present disclosure, a method for a UE to perform SL communication based on DRX and a device supporting the same are proposed.

For example, before the RX UE performing SL communication based on DRX receives SCI from the TX UE, the RX UE cannot know a period of transmission resources to be used by the TX UE. Therefore, unlike the application of a DRX cycle used in conventional Uu communication, the UE performing SL communication based on DRX needs to access a channel relatively frequently in order to detect the first SCI before receiving the first SCI. In addition, after the UE receives the first SCI, the UE may adaptively select/configure related timer value(s) for adjusting DRX ON/OFF duration by using information (e.g., resource reservation period) related to SL resources included in the SCI. In the present disclosure, for convenience of description, a UE performing SL communication based on DRX may be referred to as a DRX operating UE.

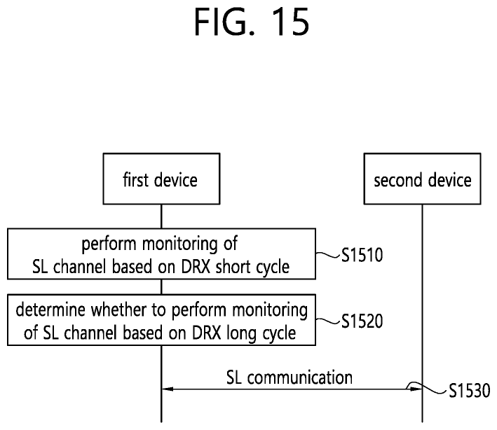

FIG. 15 shows a procedure for a DRX operating UE to perform SL communication based on a DRX long cycle or a DRX short cycle, based on an embodiment of the present disclosure. The embodiment of FIG. 15 may be combined with various embodiments of the present disclosure.

In the embodiment of FIG. 15, the first device may be an RX UE or a TX UE, and the second device may be a TX UE or an RX UE.

Referring to FIG. 15, in step S1510, the first device may perform monitoring of a transmission channel based on DRXShortCycle having a relatively short DRX cycle period. For example, the first device may be a DRX operating UE. For example, the transmission channel may be a channel related to SL transmission (e.g., PSCCH).

In step S1520, the first device may determine whether to perform monitoring of the transmission channel based on DRXLongCycle.

For example, if the first device detects SCI including an identifier related to a message to be received in an ON duration of DRXShortCycle, the first device may terminate all DRX operations based on DRXShortCycle. For example, if the first device detects SCI including an identifier related to a message to be received in an ON duration of DRXShortCycle, the first device may stop all timers related to DRXShortCycle. Herein, for example, the identifier may include at least one of a source ID, a destination ID, a zone ID, and/or a UE ID. For example, the timer related to DRXShortCycle may include at least one of OnDurationTimer, InActivityTimer, RetransmissionTimer, and/or HARQRTTTimer. In addition, in step S1530, the first device may perform SL communication (e.g., PSCCH monitoring) based on DRXLongCycle.

For example, if the first device fails to detect SCI including an identifier related to a message to be received in an ON duration of DRXShortCycle, the first device may complete all remaining DRXShortCycle-based DRX operations. Herein, for example, the identifier may include at least one of a source ID, a destination ID, a zone ID, and/or a UE ID. In addition, in step S1530, the first device may periodically perform SL communication (e.g., PSCCH monitoring) based on DRXShortCycle until the SCI is detected.

For example, if the first device detects SCI including an identifier related to a message to be received and performs SL communication based on DRXLongCycle, the first device may perform the DRX operation while repeating an ON duration and an OFF duration based on a timer related to DRXLongCycle. For example, the timer related to DRXLongCycle may include at least one of OnDurationTimer, InActivityTimer, RetransmissionTimer, and/or HARQRTTTimer. For example, the timer value related to DRXLongCycle may be predefined for the UE. For example, the timer value related to DRXLongCycle may be configured or pre- configured for the UE. For example, the base station/network may transmit information on the timer value related to DRXLongCycle to the UE. For example, the timer value related to DRXLongCycle may be pre-configured by a higher layer of the UE.

For example, while the first device is performing SL communication based on DRXLongCycle, if the number of cycles DRXLongCycle in which a PSCCH or a PSSCH related to SL reception is not received is equal to or greater than a threshold, the first device may assume/determine that a transmission pattern of the second device has changed or that the second device is no longer transmitting additional data. For example, while the first device is performing SL communication based on DRXLongCycle, if the number of consecutive cycles DRXLongCycle in which a PSCCH or a PSSCH related to SL reception is not received is equal to or greater than a threshold, the first device may assume/determine that a transmission pattern of the second device has changed or that the second device is no longer transmitting additional data. In this case, the first device may stop all timers related to DRXLongCycle. For example, the timer related to DRXLongCycle may include at least one of OnDurationTimer, InActivityTimer, RetransmissionTimer, and/or HARQRTTTimer. In addition, in step S1530, the first device may perform SL communication (e.g., PSCCH monitoring) based on DRXShortCycle in order to detect new SCI. For example, the threshold may be predefined for the UE. For example, the threshold may be configured or pre-configured for the UE. For example, the base station/network may transmit information related to the threshold to the UE. For example, the threshold may be pre-configured by a higher layer of the UE.

In the present disclosure, a method for efficiently operating DRXLongCycle and DRXShortCycle and a device supporting the same are proposed, in order for the first device not to know in advance the data transmission pattern by the second device in SL communication to perform the DRX operation.

Based on various embodiments of the present disclosure, a method for a UE to perform SL communication based on DRX and a device supporting the same are proposed.

In the present disclosure, DRXLongCycle may be referred to as LongDRXCycle, and DRXShortCycle may be referred to as ShortDRXCycle.

In the present disclosure, information may include at least one of a PSCCH (e.g., control information), a PSSCH (e.g., control information and/or data), a PSFCH (e.g., feedback), a MAC PDU, a packet, a service, and/or a message.

In the present disclosure, for example, a UE performing SL communication based on resource allocation mode 1 may receive information related to a DG resource and/or information related to a CG resource from a base station. For example, the CG resource may include a CG type 1 resource or a CG type 2 resource. In the present disclosure, the DG resource may be resource(s) configured/allocated by the base station to the UE through DCI. In the present disclosure, the CG resource may be (periodic) resource(s) configured/allocated by the base station to the UE through DCI and/or an RRC message. For example, in the case of the CG type 1 resource, the base station may transmit an RRC message including information related to the CG resource to the UE. For example, in the case of the CG type 2 resource, the base station may transmit an RRC message including information related to the CG resource to the UE, and the base station may transmit DCI including information related to activation or release of the CG resource to the UE.

In the present disclosure, for example, a UE performing SL communication based on resource allocation mode 2 may select a resource for SL transmission through channel sensing within a resource pool configured by a base station. For example, the resource may include a dynamic resource or an SPS resource. In the present disclosure, the dynamic resource may be resource(s) selected by the UE within a resource pool based on sensing. In the present disclosure, the SPS resource may be (periodic) resource(s) selected by the UE within a resource pool based on sensing.

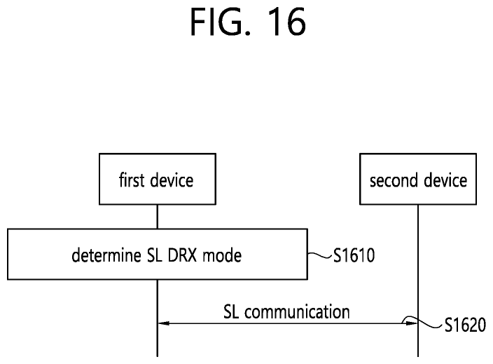

FIG. 16 shows a procedure for a UE to perform SL communication based on an SL DRX mode 1 or an SL DRX mode 2, based on an embodiment of the present disclosure. The embodiment of FIG. 16 may be combined with various embodiments of the present disclosure.

In the embodiment of FIG. 16, the first device may be an RX UE or a TX UE, and the second device may be a TX UE or an RX UE.

Referring to FIG. 16, in step S1610, the first device may determine an SL DRX mode. For example, the SL DRX mode may be either an SL DRX mode 1 or an SL DRX mode 2. For example, the first device may determine the SL DRX mode based on various embodiments of the present disclosure. In step S1620, the first device may perform SL communication based on the determined SL DRX mode.

For example, in case that the second device transmits periodic information such as a basic safety message (BSM) or a cooperative awareness message (CAM), the first device may basically perform a LongDRXCycle-based DRX operation to detect/monitor transmission of the information, and the first device may perform a ShortDRXCycle-based DRX operation according to a specific condition in order to detect/monitor retransmission or additional transmission of the information. For example, in case that the second device transmits broadcast-type information, the first device may basically perform a LongDRXCycle-based DRX operation to detect/monitor transmission of the information, and the first device may perform a ShortDRXCycle-based DRX operation according to a specific condition in order to detect/monitor retransmission or additional transmission of the information. For example, in case that the second device transmits information based on a CG type 1 resource, the first device may basically perform a LongDRXCycle-based DRX operation to detect/monitor transmission of the information, and the first device may perform a ShortDRXCycle-based DRX operation according to a specific condition in order to detect/monitor retransmission or additional transmission of the information. For example, in case that the second device transmits information based on a CG type 2 resource, the first device may basically perform a LongDRXCycle-based DRX operation to detect/monitor transmission of the information, and the first device may perform a ShortDRXCycle-based DRX operation according to a specific condition in order to detect/monitor retransmission or additional transmission of the information. For example, in case that the second device transmits information based on an SPS resource, the first device may basically perform a LongDRXCycle-based DRX operation to detect/monitor transmission of the information, and the first device may perform a ShortDRXCycle-based DRX operation according to a specific condition in order to detect/monitor retransmission or additional transmission of the information. For example, if (i) the base station knows a DRX cycle configured for the first device, and (ii) the base station can allocate transmission resource(s) to the second device according to the DRX cycle, the first device may basically perform a LongDRXCycle-based DRX operation to detect/monitor transmission of information transmitted by the second device, and the first device may perform a ShortDRXCycle-based DRX operation according to a specific condition in order to detect/monitor retransmission or additional transmission of the information. For example, in case that the second device transmits information based on resource allocation mode 1, the first device may basically perform a LongDRXCycle-based DRX operation to detect/monitor transmission of the information, and the first device may perform a ShortDRXCycle-based DRX operation according to a specific condition in order to detect/monitor retransmission or additional transmission of the information. In the present disclosure, for convenience of description, an operation in which the UE performs a LongDRXCycle-based DRX operation by default and/or an operation in which the UE performs a ShortDRXCycle-based DRX operation according to the specific condition may be referred to as the SL DRX mode 1.

For example, in case that the second device transmits aperiodic information such as a decentralized environmental notification message (DENM) or burst transmission, the first device may basically perform a ShortDRXCycle-based DRX operation to detect/monitor transmission of the information, and the first device that has detected the information through the ShortDRXCycle-based DRX operation may switch to a LongDRXCycle-based DRX operation in order to obtain a power saving gain. For example, in case that the second device transmits unicast type information, the first device may basically perform a ShortDRXCycle- based DRX operation to detect/monitor transmission of the information, and the first device that has detected the information through the ShortDRXCycle-based DRX operation may switch to a LongDRXCycle-based DRX operation in order to obtain a power saving gain. For example, in case that the second device transmits groupcast type information, the first device may basically perform a ShortDRXCycle-based DRX operation to detect/monitor transmission of the information, and the first device that has detected the information through the ShortDRXCycle-based DRX operation may switch to a LongDRXCycle-based DRX operation in order to obtain a power saving gain. For example, in case that the second device transmits information based on a DG resource, the first device may basically perform a ShortDRXCycle-based DRX operation to detect/monitor transmission of the information, and the first device that has detected the information through the ShortDRXCycle-based DRX operation may switch to a LongDRXCycle-based DRX operation in order to obtain a power saving gain. For example, in case that the second device transmits information based on a dynamic resource, the first device may basically perform a ShortDRXCycle-based DRX operation to detect/monitor transmission of the information, and the first device that has detected the information through the ShortDRXCycle-based DRX operation may switch to a LongDRXCycle-based DRX operation in order to obtain a power saving gain. In the present disclosure, for convenience of description, an operation in which the UE performs a ShortDRXCycle-based DRX operation by default and/or an operation in which the UE performs a LongDRXCycle-based DRX operation according to the specific condition may be referred to as the SL DRX mode 2.

Hereinafter, the operation of the UE in the SL DRX mode 1 suitable for periodic transmission and the operation of the UE in the SL DRX mode 2 suitable for aperiodic transmission will be described in detail. For example, the SL DRX configuration may be predefined for the UE. For example, the SL DRX configuration may be pre-configured by a higher layer of the UE. For example, the SL DRX configuration may be configured or pre-configured for the UE. For example, the base station/network may transmit the SL DRX configuration to the UE. For example, the base station/network may transmit an RRC message including the SL DRX configuration to the UE. For example, the higher layer may include an RRC layer, a V2X layer and/or an application layer. For example, the SL DRX configuration may include at least one of the following information.
drx-onDurationTimerSL
drx-SlotOffsetSL
drx-InactivityTimerSL
drx-RetransmissionTimerSL
drx-LongCycleStartOffsetSL (Long DRX cycle and start offset)
drx-ShortCycleSL
drx-ShortCycleTimerSL
drx-HARQ-RTT-TimerSL

For example, the UE may perform the operation according to the SL DRX mode 1 based on Table 7.

```
TABLE 7
SL DRX mode 1 (for periodic traffic)
The UE may:
  ● Start long DRX cycle
    ▪ during drx-onDurationTimerSL or Inactivity Timer
      ♦ If PSCCH/PSSCH(2nd SCI) is detected
        ● If destination ID is of interest
          ▪ If TDRA duration is smaller than threshold#1
            ♦ Set Inactivity Timer to max(drx-InactivityTimerSL,
            TDRA duration)
          ▪ Else
            ♦ Set Inactivity Timer to drx-InactivityTimerSL
          ▪ (Re)Start Inactivity Timer
      ♦ During active time
        ● If PSCCH/PSSCH related to other sidelink process is detected
          ▪ If total number of DRX processes is less than threshold#2
            ♦ Create a new DRX process
        ● If HARQ is disabled
          ▪ If a TB of the last transmission is not successfully decoded
            ♦ Start drx-RetransmissionTimerSL
          ▪ Else
            ♦ Use a long DRX cycle
        ● Else (if HARQ is enabled)
          ▪ If a TB of the last transmission is not successfully decoded
            and if TDRA duration is larger than threshold#3
            ♦ HARQ RTT Timer is set to the start of the next TDRA
              & start HARQ RTT Timer
          ▪ Else if a TB is successfully decoded
            ♦ Stop drx-InactivityTimer
            ♦ Stop drx-RetransmissionTimerSL
            ♦ Use a long DRX cycle
  ● TX UE termination configuration
    ▪ TX UE sends MAC CE to terminate RX UE's ON duration
      ♦ Stop drx-OnDurationTimerSL
      ♦ Stop drx-InactivityTimerSL
```

For example, the UE may perform the operation according to the SL DRX mode 2 based on Table 8.

```
TABLE 8
SL DRX mode 2 (for aperiodic traffic)
The UE may:
  ● Start short DRX cycle
    ▪ DRX with drx-ShortCycleSL
    ▪ If PSCCH/PSSCH is detected
      ♦ Terminate the short DRX cycle
      ♦ Start a long DRX cycle
    ▪ Else
      ♦ Restart short DRX cycle
  ● Long DRX cycle
    ▪ Set a long DRX cycle to the Resource Reservation Period or CG
      periodicity if present, otherwise drx-LongCycleSL
    ▪ Set Inactivity Timer to drx-InactivityTimerSL
    ▪ during drx-onDurationTimerSL or Inactivity Timer
      ♦ If PSCCH/PSSCH(2nd SCI) is detected
        ● If destination ID is of interest
          ▪ If TDRA duration is smaller than threshold#1
            ♦ Set Inactivity Timer to max(drs-InactivityTimerSL,
            TDRA duration)
          ▪ Else
            ♦ Set Inactivity Timer to drx-InactivityTimerSL
          ▪ (Re)Start Inactivity Timer
      ♦ During active time
        ● If PSCCH/PSSCH related to other sidelink process is detected
          ▪ If total number of DRX processes is less than threshold#2
            ♦ Create a new DRX process
        ● If HARQ is disabled
          ▪ If a TB of the last transmission is not successfully decoded
            ♦ Start drx-RetransmissionTimerSL
          ▪ Else
            ♦ Use a long DRX cycle
        ● Else (if HARQ is enabled)
          ▪ If a TB of the last transmission is not successfully decoded
            and if TDRA duration is larger than threshold#3
            ♦ HARQ RTT Timer is set to the start of the next TDRA
              & start HARQ RTT Timer
          ▪ Else if a TB is successfully decoded
            ♦ Stop drx-InactivityTimer
            ♦ Stop drx-RetransmissionTimerSL
            ♦ Use a long DRX cycle
    ▪ If the number of PSCCH/PSSCH detection failures becomes larger
    than threshold#4.
      ♦ Terminate the long DRX cycle
      ♦ Start a short DRX cycle
    ▪ Else
      ♦ Restart long DRX cycle
  ● TX UE termination configuration
    ▪ TX UE sends MAC CE to terminate RX UE's ON duration
      ♦ Stop drx-OnDurationTimerSL
      ♦ Stop drx-InactivityTimerSL
```

For example, at least one of threshold#1, threshold#2, threshold#3 and/or threshold#4 may be predefined for the UE. For example, at least one of threshold#1, threshold#2, threshold#3 and/or threshold#4 may be pre-configured by a higher layer of the UE. For example, at least one of threshold#1, threshold#2, threshold#3 and/or threshold#4 may be configured or pre-configured for the UE. For example, the base station/network may transmit at least one of information related to threshold#1, information related to threshold#2, information related to threshold#3, and/or information related to threshold#4 to the UE.

For example, if a new SL process is detected as in the DRX operation procedure, the second device and/or the first device may generate a new SL DRX cycle related to the SL process. In this case, for example, in order to maximize the power saving gain of the first device, the second device may interlace and transmit a plurality of TBs such that time intervals (t) of transmission resources used for TB transmission in each SL process does not overlap between different SL processes, as follows. For example, in order to maximize the power saving gain of the first device, the second device may perform burst transmission for one TB such that time intervals (t) of transmission resources used for TB transmission in each SL process does not overlap between different SL processes, as follows. For example, it is assumed that TBs transmitted by the second device in different SL processes are TBa, TBb, and TBc, respectively, and it is assumed that up to three transmission resources are configured/allocated to the second device for each TB. For example, TBa may include TBa1, TBa2, and TBa3, and TBb may include TBb 1, TBb2, and TBb3, and TBc may include TBc1, TBc2, and TBc3. In this case, the interlaced structure and the burst structure described above may be expressed as Table 9.

```
TABLE 9
▪ Maximum power saving case
  ♦ TX UE interlaces multiple TB transmissions with same periodicity &
  different offset
    ● Each TB TX is adjacent each other
    ● Ex) TBa1, TBb1, TBc1 - - - - - TBa2, TBb2, TBc2 - - - - - TBa3,
    TBb3, TBc3
  ♦ TX UE does not overlap between burst TB transmissions
    ● Ex) TBa1, TBa2, TBa3 - - - - - TBb1, TBb2, TBb3 - - - - - TBc1,
    TBc2, TBc3
```

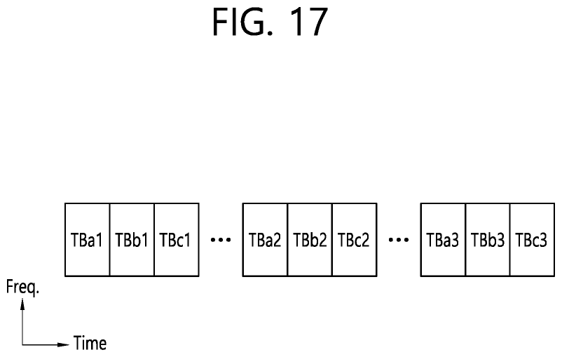

FIG. 17 shows a method for a second device to transmit TBs in an interlace form, based on an embodiment of the present disclosure. The embodiment of FIG. 17 may be combined with various embodiments of the present disclosure.

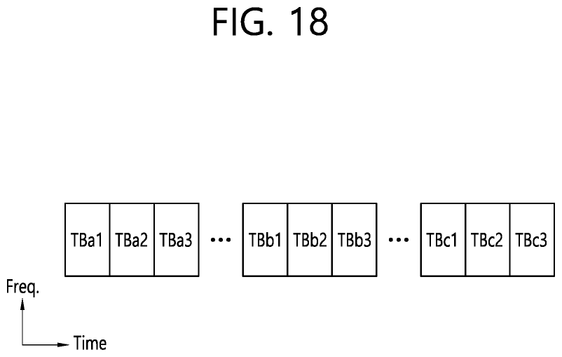

FIG. 18 shows a method for a second device to transmit TBs in a burst form, based on an embodiment of the present disclosure. The embodiment of FIG. 18 may be combined with various embodiments of the present disclosure.

Based on various embodiments of the present disclosure, a method for maximizing the power saving gain by adaptively applying different DRX operation modes used in SL communication by the UE, depending on characteristics of the transmitted data (e.g., periodic/aperiodic, cast type, resource allocation mode), and a device supporting the same are proposed.

Based on various embodiments of the present disclosure, a method for efficiently allocating SL communication resource(s) to the UE requiring the DRX operation and a device supporting the same are proposed.

For example, in the resource allocation mode 1 in which the base station schedules transmission resource(s) to the TX UE, the base station can know both resource assignment information configured for the TX UE and SL DRX cycle information used by the RX UE. Thus, for example, the TX UE and the RX UE may expect/determine that an integer multiple of a period of the CG type 1 resource or a period of the CG type 2 resource configured by the base station is configured to be equal to a period of an SL DRX cycle of the RX UE. For example, the TX UE and the RX UE may expect/determine that the period of the CG type 2 resource or the period of the CG type 2 resource configured by the base station is configured to be equal to the period of the SL DRX cycle of the RX UE. For example, the TX UE and the RX UE may expect/determine that the timing of the CG type 1 resource or the timing of the CG type 2 resource and the timing of the DG resource are included in an active time of the SL DRX cycle used by the RX UE.

For example, in the resource allocation mode 2, the TX UE may select the SPS resource such that the period of the SL DRX cycle configured by the base station to the RX UE is equal to the period of the SPS resource selected by the TX UE. For example, in the resource allocation mode 2, the TX UE may select the SPS resource such that the period of the SL DRX cycle configured by the base station to the RX UE is equal to an integer multiple of the period of the SPS resource selected by the TX UE. For example, in the resource allocation mode 2, the TX UE may select the SPS resource and/or the dynamic resource such that the timing of the SPS resource and/or the timing of the dynamic resource is included in an active time of the SL DRX cycle used by the RX UE.

For example, between UEs performing SL communication based on DRX, blind retransmission or HARQ-based retransmission may be performed during an active time of the SL DRX cycle. In this case, if the TX UE performs initial transmission for a TB at the end of the active time of the SL DRX cycle, the TX UE may perform (additional) retransmission for the TB in the active time of the next SL DRX cycle. In this case, if a packet delay budget (PDB) of the TB transmission is shorter than the period of the SL DRX cycle, the QoS required for the service may not be satisfied. In this case, exceptionally, the TX UE may perform retransmission for the TB in an inactive time of the SL DRX cycle. In this case, if the retransmission for the TB is HARQ-based retransmission, for example, if the RX UE transmits a PSFCH (e.g., HARQ NACK) to the TX UE, the TX UE receiving the PSFCH may perform the retransmission for the TB within the corresponding time (i) after SL DRX HARQ-RTT-Timer is started and (ii) before SL DRX RetransmissionTimer is started, among the inactive time. In this case, the RX UE may generate/configure the active time during the time within the inactive time of the DRX cycle in order to receive the retransmitted TB.

For example, between UEs performing SL communication based on DRX, blind retransmission or HARQ-based retransmission may be performed during an active time of the SL DRX cycle. In this case, if the TX UE performs initial transmission for a TB at the end of the active time of the SL DRX cycle, the TX UE may perform (additional) retransmission for the TB in the active time of the next SL DRX cycle. In this case, if a packet delay budget (PDB) of the TB transmission is shorter than the period of the SL DRX cycle, the QoS required for the service may not be satisfied. In this case, exceptionally, the TX UE may perform retransmission for the TB in an inactive time of the SL DRX cycle. In this case, if the retransmission for the TB is blind retransmission, the RX UE that fails to decode the initially transmitted TB in the active time of the SL DRX cycle may start SL DRX InactivityTimer and/or SL DRX RetransmissionTimer. Through this, the active time for receiving additional blind retransmission by the TX UE may be extended. For example, if the RX UE succeeds in decoding the initially transmitted TB in the active time of the SL DRX cycle, the RX UE may operate according to the original SL DRX cycle without extending the active time.

For example, if a new TB to be transmitted is generated from a higher layer of the TX UE, and if a time required for initial transmission and/or blind retransmission of the TB from a time when a lower layer of the TX UE receives the TB exceeds the active time of the SL DRX cycle, the TX UE may configure StartOffset and/or SlotOffset for the SL DRX cycle, and the TX UE may perform initial transmission and/or blind retransmission of the TB during an active time within the newly configured SL DRX cycle. In this case, the TX UE may transmit the adjusted StartOffset and/or SlotOffset to the RX UE in the active time within the existing SL DRX cycle, and the RX UE may perform SL communication according to the newly configured DRX cycle based on the adjusted StartOffset and/or SlotOffset. Herein, for example, the adjusted StartOffset and/or SlotOffset may be transmitted to the RX UE through PC5 RRC signaling or a PSCCH/PSSCH.

For example, the base station may configure an SL resource pool configured for a UE not operating in DRX to not overlap an active time of an SL DRX cycle or an SL resource pool configured for a UE operating in DRX in the time domain. For example, the base station may configure adjacently in the time domain such that an SL resource pool configured for a UE not operating in DRX does not overlap with an active time of an SL DRX cycle or an SL resource pool configured for a UE operating in DRX in the time domain. For example, the base station may configure an SL resource pool configured for a UE not operating in SL DRX to include an active time of an SL DRX cycle or an SL resource pool configured for a UE operating in SL DRX in the time domain.

For example, the active time within the SL DRX cycle may be limited to exist within the SL resource pool configured for the UE operating in SL DRX, and the UE may stop at least one of OnDurationTimer, InactivityTimer, and/or RetransmissionTimer at a time when the timer(s) is out of the SL resource pool in the time domain while the timer(s) are running. For example, the timer(s) may be limited to count only for logical slots or subframes included in the SL resource pool.

Based on various embodiments of the present disclosure, in order to save power of the UE performing the SL DRX operation, a method for allocating transmission resource(s) to the DRX operating UE by the base station or selecting transmission resource(s) by the DRX operating UE and a device supporting the same are proposed.

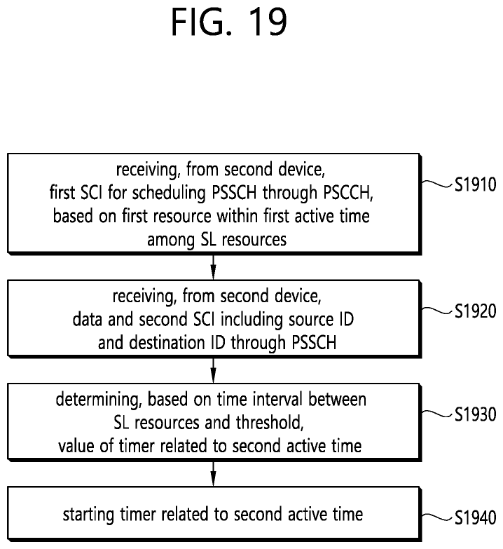

FIG. 19 shows a method for a first device to perform wireless communication based on a sidelink (SL) discontinuous reception (DRX) configuration, based on an embodiment of the present disclosure. The embodiment of FIG. 19 may be combined with various embodiments of the present disclosure.

Referring to FIG. 19, in step S1910, the first device may receive, from a second device, first sidelink control information (SCI) for scheduling a physical sidelink shared channel (PSSCH) through a physical sidelink control channel (PSCCH), based on a first resource within a first active time among a plurality of SL resources. For example, information related to the first active time may be included in the SL DRX configuration. In step S1920, the first device may receive, from the second device, data and second SCI including a source ID and a destination ID through the PSSCH. In step S1930, the first device may determine, based on a time interval between the plurality of SL resources and a threshold, a value of a timer related to a second active time. In step S1940, the first device may start the timer related to the second active time.

For example, the SL DRX configuration may be an SL DRX configuration related to the source ID and the destination ID.

For example, based on that the time interval between the plurality of SL resources is less than or equal to the threshold, the value of the timer related to the second active time may be determined to include a time domain of the plurality of SL resources.

For example, based on that the time interval between the plurality of SL resources is greater than the threshold, the value of the timer related to the second active time may be determined to include only a time domain of the first resource among the plurality of SL resources.

Additionally, for example, the first device may receive, from the second device, information representing a transition to an inactive state, and the first device may transition to the inactive state based on the information representing the transition to the inactive state.

For example, the plurality of SL resources may be resources included in one period. For example, based on that a period value of the plurality of SL resources is less than a value of a configured timer related to the second active time, the value of the timer related to the second active time may be determined as the value of the configured timer. For example, based on that the period value of the plurality of SL resources is greater than the value of the configured timer related to the second active time, the value of the timer related to the second active time may be determined as the period value.

Additionally, for example, the first device may determine, based on a subchannel index and a slot index of a resource related to the PSSCH, a physical sidelink feedback channel (PSFCH) resource related to the PSSCH. For example, based on that a time interval between the resource related to the PSSCH and the PSFCH resource is less than the threshold, a value of a timer related to a third active time of the second device may be determined to be greater than or equal to the time interval between the resource related to the PSSCH and the PSFCH resource. For example, based on that a time interval between the resource related to the PSSCH and the PSFCH resource is greater than the threshold, a hybrid automatic repeat request (HARQ)-round trip time (RTT) timer may be started by the second device, and a value of the HARQ-RTT timer may be determined to be equal to the time interval between the resource related to the PSSCH and the PSFCH resource.

Additionally, for example, the first device may stop the timer related to the second active time, based on successfully decoding the data.

For example, the timer related to the second active time may be an inactivity timer or a retransmission timer. For example, the plurality of SL resources may be resources allocated by a dynamic grant, resources allocated by a configured grant, or resources selected by the second device.

The proposed method can be applied to the device(s) based on various embodiments of the present disclosure. First, the processor 102 of the first device 100 may control the transceiver 106 to receive, from a second device, first sidelink control information (SCI) for scheduling a physical sidelink shared channel (PSSCH) through a physical sidelink control channel (PSCCH), based on a first resource within a first active time among a plurality of SL resources. For example, information related to the first active time may be included in the SL DRX configuration. In addition, the processor 102 of the first device 100 may control the transceiver 106 to receive, from the second device, data and second SCI including a source ID and a destination ID through the PSSCH. In addition, the processor 102 of the first device 100 may determine, based on a time interval between the plurality of SL resources and a threshold, a value of a timer related to a second active time. In addition, the processor 102 of the first device 100 may start the timer related to the second active time.

Based on an embodiment of the present disclosure, a first device adapted to perform wireless communication based on a sidelink (SL) discontinuous reception (DRX) configuration may be provided. For example, the first device may comprise: one or more memories storing instructions; one or more transceivers; and one or more processors connected to the one or more memories and the one or more transceivers. For example, the one or more processors may execute the instructions to: receive, from a second device, first sidelink control information (SCI) for scheduling a physical sidelink shared channel (PSSCH) through a physical sidelink control channel (PSCCH), based on a first resource within a first active time among a plurality of SL resources, wherein information related to the first active time is included in the SL DRX configuration; receive, from the second device, data and second SCI including a source ID and a destination ID through the PSSCH; determine, based on a time interval between the plurality of SL resources and a threshold, a value of a timer related to a second active time; and start the timer related to the second active time.

Based on an embodiment of the present disclosure, an apparatus adapted to control a first user equipment (UE) performing wireless communication based on a sidelink (SL) discontinuous reception (DRX) configuration may be provided. For example, the apparatus may comprise: one or more processors; and one or more memories operably connected to the one or more processors and storing instructions. For example, the one or more processors may execute the instructions to: receive, from a second UE, first sidelink control information (SCI) for scheduling a physical sidelink shared channel (PSSCH) through a physical sidelink control channel (PSCCH), based on a first resource within a first active time among a plurality of SL resources, wherein information related to the first active time is included in the SL DRX configuration; receive, from the second UE, data and second SCI including a source ID and a destination ID through the PSSCH; determine, based on a time interval between the plurality of SL resources and a threshold, a value of a timer related to a second active time; and start the timer related to the second active time.

Based on an embodiment of the present disclosure, a non-transitory computer-readable storage medium storing instructions may be provided. For example, the instructions, when executed, may cause a first device to: receive, from a second device, first sidelink control information (SCI) for scheduling a physical sidelink shared channel (PSSCH) through a physical sidelink control channel (PSCCH), based on a first resource within a first active time among a plurality of SL resources, wherein information related to the first active time is included in a sidelink (SL) discontinuous reception (DRX) configuration; receive, from the second device, data and second SCI including a source ID and a destination ID through the PSSCH; determine, based on a time interval between the plurality of SL resources and a threshold, a value of a timer related to a second active time; and start the timer related to the second active time.

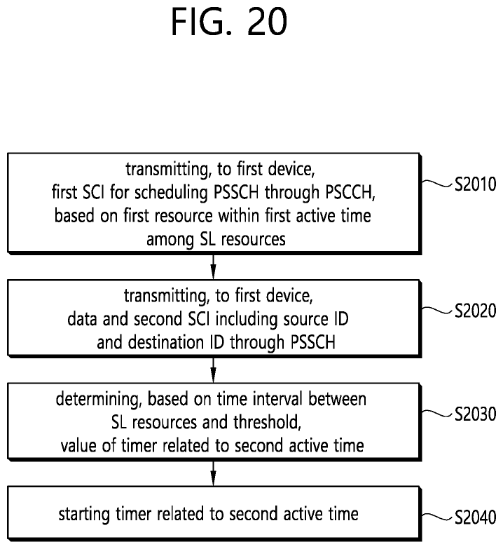

FIG. 20 shows a method for a second device to perform wireless communication based on a sidelink (SL) discontinuous reception (DRX) configuration, based on an embodiment of the present disclosure. The embodiment of FIG. 20 may be combined with various embodiments of the present disclosure.

Referring to FIG. 20, in step S2010, the second device may transmit, to a first device, first sidelink control information (SCI) for scheduling a physical sidelink shared channel (PSSCH) through a physical sidelink control channel (PSCCH), based on a first resource within a first active time among a plurality of SL resources. For example, information related to the first active time may be included in the SL DRX configuration. In step S2020, the second device may transmit, to the first device, data and second SCI including a source ID and a destination ID through the PSSCH. In step S2030, the second device may determine, based on a time interval between the plurality of SL resources and a threshold, a value of a timer related to a second active time. In step S2040, the second device may start the timer related to the second active time.

The proposed method can be applied to the device(s) based on various embodiments of the present disclosure. First, the processor 202 of the second device 200 may control the transceiver 206 to transmit, to a first device, first sidelink control information (SCI) for scheduling a physical sidelink shared channel (PSSCH) through a physical sidelink control channel (PSCCH), based on a first resource within a first active time among a plurality of SL resources. For example, information related to the first active time may be included in the SL DRX configuration. In addition, the processor 202 of the second device 200 may control the transceiver 206 to transmit, to the first device, data and second SCI including a source ID and a destination ID through the PSSCH. In addition, the processor 202 of the second device 200 may determine, based on a time interval between the plurality of SL resources and a threshold, a value of a timer related to a second active time. In addition, the processor 202 of the second device 200 may start the timer related to the second active time.

Based on an embodiment of the present disclosure, a second device adapted to perform wireless communication based on a sidelink (SL) discontinuous reception (DRX) configuration may be provided. For example, the second device may comprise: one or more memories storing instructions; one or more transceivers; and one or more processors connected to the one or more memories and the one or more transceivers. For example, the one or more processors may execute the instructions to: transmit, to a first device, first sidelink control information (SCI) for scheduling a physical sidelink shared channel (PSSCH) through a physical sidelink control channel (PSCCH), based on a first resource within a first active time among a plurality of SL resources, wherein information related to the first active time is included in the SL DRX configuration; transmit, to the first device, data and second SCI including a source ID and a destination ID through the PSSCH; determine, based on a time interval between the plurality of SL resources and a threshold, a value of a timer related to a second active time; and start the timer related to the second active time.

Based on an embodiment of the present disclosure, an apparatus adapted to control a second user equipment (UE) performing wireless communication based on a sidelink (SL) discontinuous reception (DRX) configuration may be provided. For example, the apparatus may comprise: one or more processors; and one or more memories operably connected to the one or more processors and storing instructions. For example, the one or more processors may execute the instructions to: transmit, to a first UE, first sidelink control information (SCI) for scheduling a physical sidelink shared channel (PSSCH) through a physical sidelink control channel (PSCCH), based on a first resource within a first active time among a plurality of SL resources, wherein information related to the first active time is included in the SL DRX configuration; transmit, to the first UE, data and second SCI including a source ID and a destination ID through the PSSCH; determine, based on a time interval between the plurality of SL resources and a threshold, a value of a timer related to a second active time; and start the timer related to the second active time.

Based on an embodiment of the present disclosure, a non-transitory computer-readable storage medium storing instructions may be provided. For example, the instructions, when executed, may cause a second device to: transmit, to a first device, first sidelink control information (SCI) for scheduling a physical sidelink shared channel (PSSCH) through a physical sidelink control channel (PSCCH), based on a first resource within a first active time among a plurality of SL resources, wherein information related to the first active time is included in a sidelink (SL) discontinuous reception (DRX) configuration; transmit, to the first device, data and second SCI including a source ID and a destination ID through the PSSCH; determine, based on a time interval between the plurality of SL resources and a threshold, a value of a timer related to a second active time; and start the timer related to the second active time.

Various embodiments of the present disclosure may be combined with each other.

Hereinafter, device(s) to which various embodiments of the present disclosure can be applied will be described.

The various descriptions, functions, procedures, proposals, methods, and/or operational flowcharts of the present disclosure described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

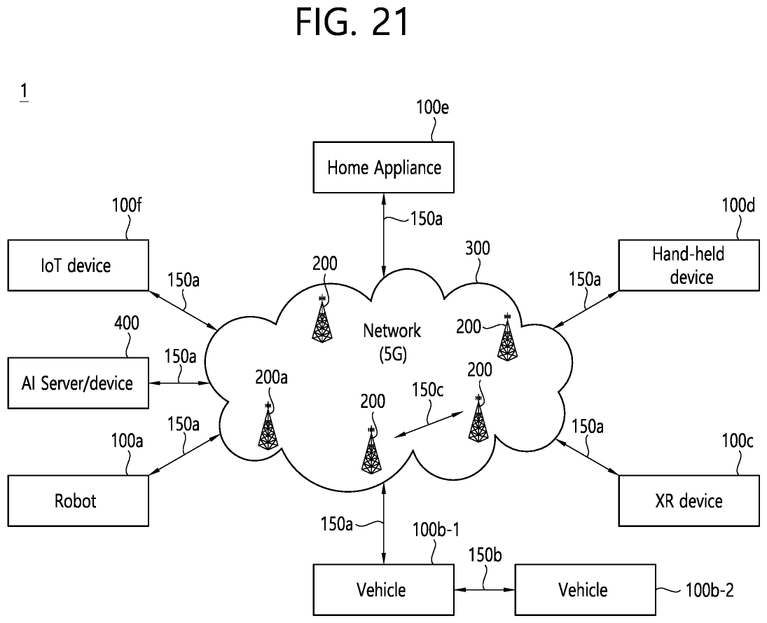

FIG. 21 shows a communication system 1, based on an embodiment of the present disclosure.

Referring to FIG. 21, a communication system 1 to which various embodiments of the present disclosure are applied includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

Here, wireless communication technology implemented in wireless devices 100a to 100f of the present disclosure may include Narrowband Internet of Things for low-power communication in addition to LTE, NR, and 6G. In this case, for example, NB-IoT technology may be an example of Low Power Wide Area Network (LPWAN) technology and may be implemented as standards such as LTE Cat NB1, and/or LTE Cat NB2, and is not limited to the name described above. Additionally or alternatively, the wireless communication technology implemented in the wireless devices 100a to 100f of the present disclosure may perform communication based on LTE-M technology. In this case, as an example, the LTE-M technology may be an example of the LPWAN and may be called by various names including enhanced Machine Type Communication (eMTC), and the like. For example, the LTE-M technology may be implemented as at least any one of various standards such as 1) LTE CAT 0, 2) LTE Cat M1, 3) LTE Cat M2, 4) LTE non-Bandwidth Limited (non-BL), 5) LTE-MTC, 6) LTE Machine Type Communication, and/or 7) LTE M, and is not limited to the name described above. Additionally or alternatively, the wireless communication technology implemented in the wireless devices 100a to 100f of the present disclosure may include at least one of Bluetooth, Low Power Wide Area Network (LPWAN), and ZigBee considering the low-power communication, and is not limited to the name described above. As an example, the ZigBee technology may generate personal area networks (PAN) related to small/low-power digital communication based on various standards including IEEE 802.15.4, and the like, and may be called by various names.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

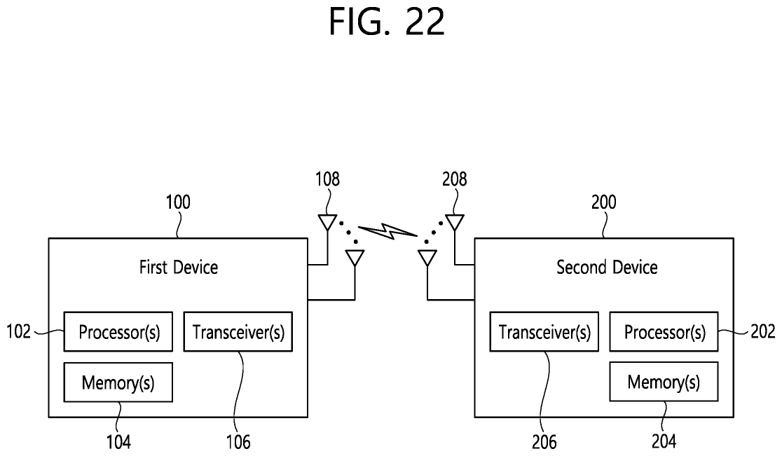

FIG. 22 shows wireless devices, based on an embodiment of the present disclosure.

Referring to FIG. 22, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 21.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

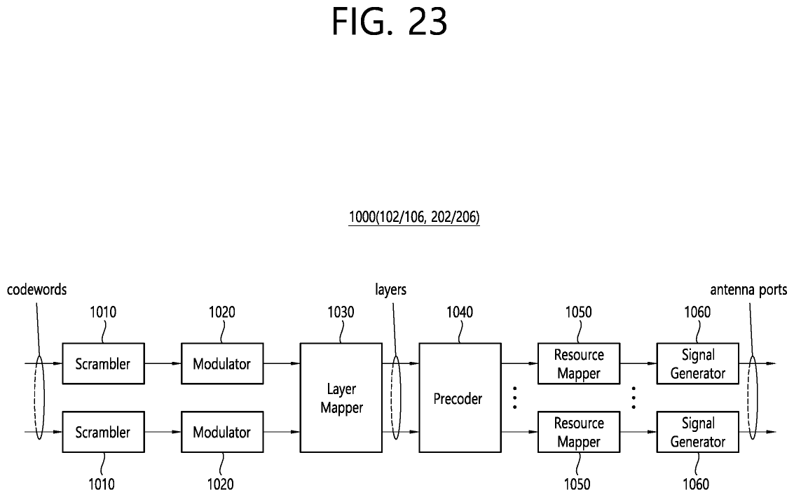

FIG. 23 shows a signal process circuit for a transmission signal, based on an embodiment of the present disclosure.

Referring to FIG. 23, a signal processing circuit 1000 may include scramblers 1010, modulators 1020, a layer mapper 1030, a precoder 1040, resource mappers 1050, and signal generators 1060. An operation/function of FIG. 23 may be performed, without being limited to, the processors 102 and 202 and/or the transceivers 106 and 206 of FIG. 22. Hardware elements of FIG. 23 may be implemented by the processors 102 and 202 and/or the transceivers 106 and 206 of FIG. 22. For example, blocks 1010 to 1060 may be implemented by the processors 102 and 202 of FIG. 22. Alternatively, the blocks 1010 to 1050 may be implemented by the processors 102 and 202 of FIG. 22 and the block 1060 may be implemented by the transceivers 106 and 206 of FIG. 22.

Codewords may be converted into radio signals via the signal processing circuit 1000 of FIG. 23. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

Specifically, the codewords may be converted into scrambled bit sequences by the scramblers 1010. Scramble sequences used for scrambling may be generated based on an initialization value, and the initialization value may include ID information of a wireless device. The scrambled bit sequences may be modulated to modulation symbol sequences by the modulators 1020. A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper 1030. Modulation symbols of each transport layer may be mapped (precoded) to corresponding antenna port(s) by the precoder 1040. Outputs z of the precoder 1040 may be obtained by multiplying outputs y of the layer mapper 1030 by an N*M precoding matrix W. Herein, N is the number of antenna ports and M is the number of transport layers. The precoder 1040 may perform precoding after performing transform precoding (e.g., DFT) for complex modulation symbols. Alternatively, the precoder 1040 may perform precoding without performing transform precoding.

The resource mappers 1050 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 1060 may generate radio signals from the mapped modulation symbols and the generated radio signals may be transmitted to other devices through each antenna. For this purpose, the signal generators 1060 may include Inverse Fast Fourier Transform (IFFT) modules, Cyclic Prefix (CP) inserters, Digital-to-Analog Converters (DACs), and frequency up-converters.

Signal processing procedures for a signal received in the wireless device may be configured in a reverse manner of the signal processing procedures 1010 to 1060 of FIG. 23. For example, the wireless devices (e.g., 100 and 200 of FIG. 22) may receive radio signals from the exterior through the antenna ports/transceivers. The received radio signals may be converted into baseband signals through signal restorers. To this end, the signal restorers may include frequency downlink converters, Analog-to-Digital Converters (ADCs), CP remover, and Fast Fourier Transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

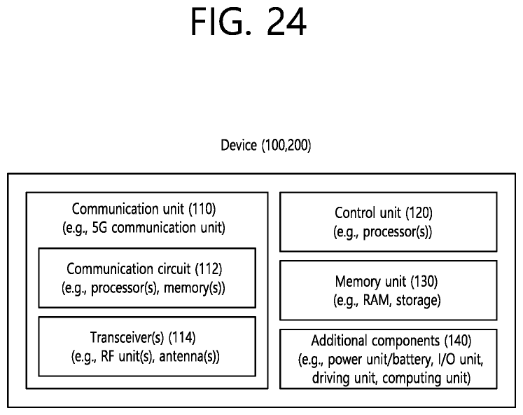

FIG. 24 shows another example of a wireless device, based on an embodiment of the present disclosure. The wireless device may be implemented in various forms according to a use-case/service (refer to FIG. 21).

Referring to FIG. 24, wireless devices 100 and 200 may correspond to the wireless devices 100 and 200 of FIG. 22 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 22. For example, the transceiver(s) 114 may include the one or more transceivers 106 and 206 and/or the one or more antennas 108 and 208 of FIG. 22. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 21), the vehicles (100b-1 and 100b-2 of FIG. 21), the XR device (100c of FIG. 21), the hand-held device (100d of FIG. 21), the home appliance (100e of FIG. 21), the IoT device (100f of FIG. 21), a digital broadcast terminal, a hologram device, a public safety device, an MTC device, a medicine device, a fintech device (or a finance device), a security device, a climate/environment device, the AI server/device (400 of FIG. 21), the BSs (200 of FIG. 21), a network node, etc. The wireless device may be used in a mobile or fixed place according to a use-example/service.

In FIG. 24, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof

Hereinafter, an example of implementing FIG. 24 will be described in detail with reference to the drawings.

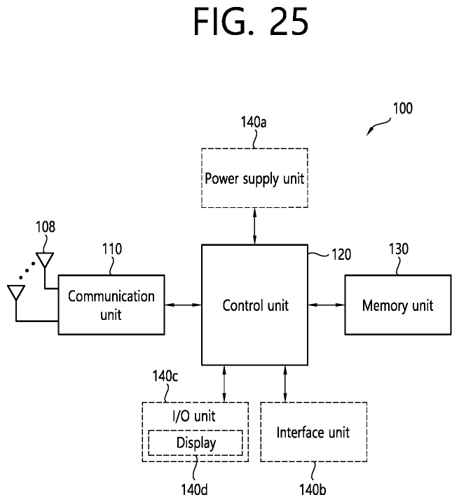

FIG. 25 shows a hand-held device, based on an embodiment of the present disclosure. The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a Mobile Subscriber Station (MSS), a Subscriber Station (SS), an Advanced Mobile Station (AMS), or a Wireless Terminal (WT).

Referring to FIG. 25, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c correspond to the blocks 110 to 130/140 of FIG. 24, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an Application Processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

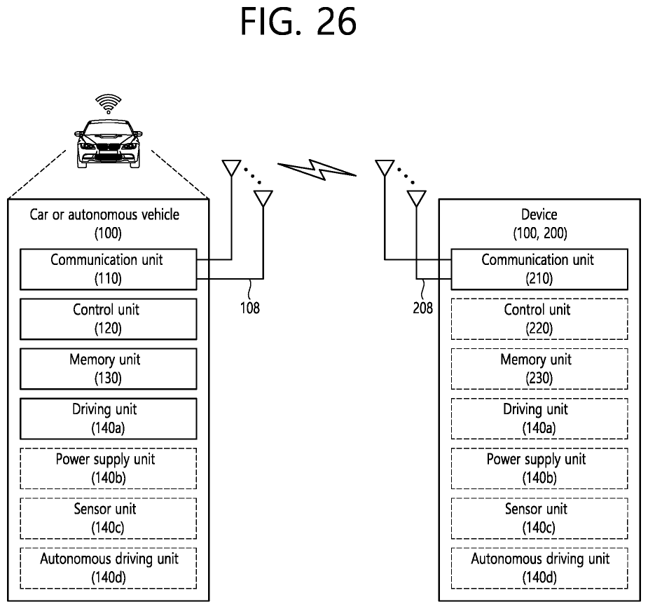

FIG. 26 shows a vehicle or an autonomous vehicle, based on an embodiment of the present disclosure. The vehicle or autonomous vehicle may be implemented by a mobile robot, a car, a train, a manned/unmanned Aerial Vehicle (AV), a ship, etc.

Referring to FIG. 26, a vehicle or autonomous vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 24, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous vehicle 100. The control unit 120 may include an Electronic Control Unit (ECU). The driving unit 140a may cause the vehicle or the autonomous vehicle 100 to drive on a road. The driving unit 140a may include an engine, a motor, a powertrain, a wheel, a brake, a steering device, etc. The power supply unit 140b may supply power to the vehicle or the autonomous vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous vehicles and provide the predicted traffic information data to the vehicles or the autonomous vehicles.

Claims in the present description can be combined in a various way. For instance, technical features in method claims of the present description can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method.

1. A method for performing wireless communication by a first device based on a sidelink (SL) discontinuous reception (DRX) configuration, the method comprising:
receiving, from a second device, first sidelink control information (SCI) for scheduling a physical sidelink shared channel (PSSCH) through a physical sidelink control channel (PSCCH), based on a first resource within a first active time among a plurality of SL resources, wherein information related to the first active time is included in the SL DRX configuration;
receiving, from the second device, data and second SCI including a source ID and a destination ID through the PSSCH;
determining, based on a time interval between the plurality of SL resources and a threshold, a value of a timer related to a second active time; and
starting the timer related to the second active time.

2. The method of claim 1, wherein the SL DRX configuration is an SL DRX configuration related to the source ID and the destination ID.

3. The method of claim 1, wherein, based on that the time interval between the plurality of SL resources is less than or equal to the threshold, the value of the timer related to the second active time is determined to include a time domain of the plurality of SL resources.

4. The method of claim 1, wherein, based on that the time interval between the plurality of SL resources is greater than the threshold, the value of the timer related to the second active time is determined to include only a time domain of the first resource among the plurality of SL resources.

5. The method of claim 1, further comprising:
receiving, from the second device, information representing a transition to an inactive state; and
transitioning to the inactive state based on the information representing the transition to the inactive state.

6. The method of claim 1, wherein the plurality of SL resources are resources included in one period.

7. The method of claim 6, wherein, based on that a period value of the plurality of SL resources is less than a value of a configured timer related to the second active time, the value of the timer related to the second active time is determined as the value of the configured timer, and
wherein, based on that the period value of the plurality of SL resources is greater than the value of the configured timer related to the second active time, the value of the timer related to the second active time is determined as the period value.

8. The method of claim 1, further comprising:
determining, based on a subchannel index and a slot index of a resource related to the PSSCH, a physical sidelink feedback channel (PSFCH) resource related to the PSSCH.

9. The method of claim 8, wherein, based on that a time interval between the resource related to the PSSCH and the PSFCH resource is less than the threshold, a value of a timer related to a third active time of the second device is determined to be greater than or equal to the time interval between the resource related to the PS SCH and the PSFCH resource.

10. The method of claim 8, wherein, based on that a time interval between the resource related to the PSSCH and the PSFCH resource is greater than the threshold, a hybrid automatic repeat request (HARQ)-round trip time (RTT) timer is started by the second device, and wherein a value of the HARQ-RTT timer is determined to be equal to the time interval between the resource related to the PSSCH and the PSFCH resource.

11. The method of claim 1, further comprising:
stopping the timer related to the second active time, based on successfully decoding the data.

12. The method of claim 1, wherein the timer related to the second active time is an inactivity timer or a retransmission timer.

13. The method of claim 1, wherein the plurality of SL resources are resources allocated by a dynamic grant, resources allocated by a configured grant, or resources selected by the second device.

14. A first device adapted to perform wireless communication based on a sidelink (SL) discontinuous reception (DRX) configuration, the first device comprising:
at least one transceiver;
at least one processor; and
at least one memory connected to the at least one processor and storing instructions that, based on being executed by the at least one processor, perform operations comprising:
receiving, from a second device, first sidelink control information (SCI) for scheduling a physical sidelink shared channel (PSSCH) through a physical sidelink control channel (PSCCH), based on a first resource within a first active time among a plurality of SL resources, wherein information related to the first active time is included in the SL DRX configuration;
receiving, from the second device, data and second SCI including a source ID and a destination ID through the PSSCH;
determining, based on a time interval between the plurality of SL resources and a threshold, a value of a timer related to a second active time; and
starting the timer related to the second active time.

15. A processing device adapted to control a first device performing wireless communication based on a sidelink (SL) discontinuous reception (DRX) configuration, the processing device apparatus comprising:
at least one processor; and
at least one memory connected to the at least one processor and storing instructions that, based on being executed by the at least one processor, perform operations comprising:
receiving, from a second device, first sidelink control information (SCI) for scheduling a physical sidelink shared channel (PSSCH) through a physical sidelink control channel (PSCCH), based on a first resource within a first active time among a plurality of SL resources, wherein information related to the first active time is included in the SL DRX configuration;
receiving, from the second device, data and second SCI including a source ID and a destination ID through the PSSCH;
determining, based on a time interval between the plurality of SL resources and a threshold, a value of a timer related to a second active time; and
starting the timer related to the second active time.

16-20. (canceled)

21. The first device of claim 14, wherein the SL DRX configuration is an SL DRX configuration related to the source ID and the destination ID.

22. The first device of claim 14, wherein, based on that the time interval between the plurality of SL resources is less than or equal to the threshold, the value of the timer related to the second active time is determined to include a time domain of the plurality of SL resources.

23. The first device of claim 14, wherein, based on that the time interval between the plurality of SL resources is greater than the threshold, the value of the timer related to the second active time is determined to include only a time domain of the first resource among the plurality of SL resources.

24. The processing device of claim 15, wherein the SL DRX configuration is an SL DRX configuration related to the source ID and the destination ID.

25. The processing device of claim 15, wherein, based on that the time interval between the plurality of SL resources is less than or equal to the threshold, the value of the timer related to the second active time is determined to include a time domain of the plurality of SL resources.
